(19) United States
(12) Patent Application Publication
(10) Pub. No.: US 2017/0363885 A1
(43) Pub. Date: Dec. 21, 2017

(54) IMAGE ALIGNMENT SYSTEMS AND METHODS

(71) Applicant: POGOTEC, INC., Roanoke, VA (US)

(72) Inventors: RONALD D. BLUM, ROANOKE, VA (US); WILLIAM KOKONASKI, BELFAIR, WA (US); AMITAVA GUPTA, ROANOKE, VA (US); STEFAN BAUER, BERN (CH); JEAN-NOEL FEHR, NEUCHÂTEL (CH); RICHARD CLOMPUS, TRINIDAD, CA (US); MASSIMO PINAZZA, DOMEGGE DI CADORE (IT); CLAUDIO DALLA LONGA, VALDOBBIADENE (IT); WALTER DANNHARDT, ROANOKE, VA (US); LINZI BERRY, SAN FRANCISCO, CA (US); PAUL CHANG, SAN FRANCISCO, CA (US); ANDY LEE, SOUTH SAN FRANCISCO, CA (US)

(73) Assignee: POGOTEC, INC., ROANOKE, VA (US)

(21) Appl. No.: 15/627,759

(22) Filed: Jun. 20, 2017

Related U.S. Application Data
(60) Provisional application No. 62/352,395, filed on Jun. 20, 2016.
(60) Provisional application No. 62/370,520, filed on Aug. 3, 2016.
(60) Provisional application No. 62/381,258, filed on Aug. 30, 2016.
(60) Provisional application No. 62/403,493, filed on Oct. 3, 2016.
(60) Provisional application No. 62/421,177, filed on Nov. 11, 2016.
(60) Provisional application No. 62/439,827, filed on Dec. 28, 2016.
(60) Provisional application No. 62/458,181, filed on Feb. 13, 2017.

(51) Int. Cl. G02C 11/00; G02B 27/01; G02C 13/00

(52) U.S. Cl. CPC G02C 11/10; G02B 27/017; G02B 2027/0178; G03B 2213/025; G02C 13/005

(57) ABSTRACT

Examples described herein include methods and systems for adjusting images which may be captured, for example, by a wearable camera. The wearable camera may be devoid of a viewfinder. Accordingly, it may be desirable to adjust images captured by the wearable camera prior to display to a user. Image adjustment techniques may employ physical wedges, calibration techniques, and/or machine learning techniques as described herein.

### CROSS-REFERENCE TO RELATED APPLICATIONS

This application claims the benefit under 35 U.S.C. 119 of the earlier filing date of U.S. Provisional Application No. 62/352,395 entitled “CAMERA SYSTEM AND METHODS,” filed Jun. 20, 2016. The aforementioned provisional application is hereby incorporated by reference in its entirety, for any purpose.

This application claims the benefit under 35 U.S.C. 119 of the earlier filing date of U.S. Provisional Application No. 62/370,520 entitled “WINK SENSOR SYSTEM,” filed Aug. 3, 2016. The aforementioned provisional application is hereby incorporated by reference in its entirety, for any purpose.

This application claims the benefit under 35 U.S.C. 119 of the earlier filing date of U.S. Provisional Application No. 62/381,258 entitled “WEARABLE FLASH FOR WEARABLE CAMERA,” filed Aug. 30, 2016. The aforementioned provisional application is hereby incorporated by reference in its entirety, for any purpose.

This application claims the benefit under 35 U.S.C. 119 of the earlier filing date of U.S. Provisional Application No. 62/403,493 entitled “EYEWEAR CAMERA IMAGE ADJUSTMENT MEANS & SYSTEM.” filed Oct. 3, 2016. The aforementioned provisional application is hereby incorporated by reference in its entirety, for any purpose.

This application claims the benefit under 35 U.S.C. 119 of the earlier filing date of U.S. Provisional Application No. 62/421,177 entitled “IMAGE CAPTURE AUTO-CENTERING, AUTO-ROTATION, AUTO-ALIGNMENT, AUTO-CROPPING,” filed Nov. 11, 2016. The aforementioned provisional application is hereby incorporated by reference in its entirety, for any purpose.

This application claims the benefit under 35 U.S.C. 119 of the earlier filing date of U.S. Provisional Application No. 62/439,827 entitled “IMAGE STABILIZATION AND IMPROVEMENT IN IMAGE QUALITY,” filed Dec. 28, 2016. The aforementioned provisional application is hereby incorporated by reference in its entirety, for any purpose.

This application claims the benefit under 35 U.S.C. 119 of the earlier filing date of U.S. Provisional Application No. 62/458,181 entitled “CONTROLLING IMAGE ORIENTATION, LOCATION, STABILIZATION AND QUALITY,” filed Feb. 13, 2017. The aforementioned provisional application is hereby incorporated by reference in its entirety, for any purpose.

### TECHNICAL FIELD

The present disclosure relates to image alignment systems and methods. Examples are described which may facilitate the adjustment of images such that alignment (e.g. orientation) of features is altered and/or improved. Examples may find particular use with body-worn cameras.

### BACKGROUND

The number and types of commercially available electronic wearable devices continues to expand. Forecasters are predicting that the electronic wearable devices market will more than quadruple in the next ten years.

Generally, cameras have become increasingly smaller and may increasingly be found in body-worn and/or body-held devices (e.g. wearables, portables, phones, computers). It may be difficult, cumbersome, or impossible to accurately orient the camera with respect to a subject prior to capturing an image. Generally, these body-worn and/or body-held cameras may be devoid of a view finder. Given that in many cases the photographer is not able to see what he or she is capturing there is a pressing need for improved image stabilization and auto-alignment, auto-centering, auto-rotation of captured images.

### SUMMARY

Examples of methods are described herein which may include capturing a first image with a camera attached to a wearable device in a manner which fixes a line of sight of the camera relative to the wearable device, transmitting the first image to a computing system, receiving or providing an indication of an adjustment to a location relative to a center of the first image or an orientation of the first image, generating a configuration parameter corresponding to the adjustment to the location relative to the center of the first image or the orientation of the first image, storing the configuration parameter in memory of the computing system, retrieving the configuration parameter following receipt of a second image from the camera, and/or automatically adjusting the second image in accordance with the configuration parameter.

In some examples, the wearable device is eyewear. In some examples, the wearable device is an eyeglass frame, an eyeglass frame temple, a ring, a helmet, a necklace, a bracelet, a watch, a band, a belt, a body wear, a head wear, an ear wear, or a foot wear.

Another example method may include capturing an image with a camera coupled to an eyewear frame; displaying the image together with a layout of regions; and/or based on a region in which an intended central feature of the image appeared, recommending a wedge having a particular angle and orientation for attachment between the camera and the eyewear frame.

In some examples, such a method may further include identifying, using a computer system, the intended central feature of the image.

In some examples, such a method may further include attaching the wedge between the camera and the eyewear frame using magnets.

In some examples, the particular angle is based on a distance between a center of the image and the intended central feature.

In some examples, the orientation is based on which side of a center of the image the intended central feature appeared.

Examples of camera systems are described herein. An example camera system may include an eyewear temple, a camera attached to the eyewear temple, and/or a wedge between the eyewear temple and the camera.

In some examples, an angle of the wedge is selected to adjust a view of the camera. In some examples, the angle of the wedge is select to align the view of the camera parallel to a desired line of sight.

In some examples, the wedge is attached to the camera and the eyewear temple with magnets. In some examples, the wedge is integral with the camera or integral with a structure placed between the camera and the eyewear temple.

Another example method may include holding a computing system in a particular position relative to a body-worn camera; displaying a machine-readable symbol on a display of the computing system; capturing an image of the machine-readable symbol with the body-worn camera; and/or analyzing the image of the machine-readable symbol to determine an amount of rotation, shift, crop, or combinations thereof, to align the image of the machine-readable symbol with a view of a user.

In some examples, the machine-readable symbol may include a grid, a bar code, a dot, or combinations thereof.

In some examples, such a method may further include downloading the image of the machine-readable symbol from the body-worn camera to the computing system.

In some examples, the analyzing the image may include comparing an orientation of the machine-readable symbol in the image with an orientation of the machine-readable symbol on the display.

Examples of computing systems are described herein. An example computing system may include at least one processing unit and/or memory encoded with executable instructions which, when executed by the at least one processing unit, cause the computing system to: receive an image captured by a wearable camera, and manipulate the image in accordance with a machine learning algorithm based on a model developed using a training set of images.

In some examples, manipulating the image may include rotate the image, center the image, crop the image, stabilize the image, color balance the image, render the image in an arbitrary color scheme, restore true color of the image, noise reduction of the image, contrast enhancement of the image, selective alteration of image contrast of the image, enhancement of image resolution, image stitching, enhancement of field of view of the image, enhancement of depth of view of the image, or combinations thereof.

In some examples, the machine learning algorithm may include one or more of decision forest/regression forest, neural networks, K nearest neighbors classifier, linear or logistic regression, naive Bayes classifier, or support vector machine classification/regression.

In some examples, the computing system may further include one or more image filters. In some examples, the computing system may include an external unit into which the wearable camera may be placed to charge and/or transfer data. In some examples, the computing system may include a smartphone in communication with the wearable camera.

Examples of systems are described herein. An example system may include a camera devoid of a viewfinder, where the camera may include an image sensor, a memory, and a sensor configured to provide an output indicative of a direction of gravitation attraction. The system may include a computing system configured to receive data indicative of an image captured by the image sensor and the output indicative of the direction of gravitation attraction, the computing system configured to rotate the image based on the direction of gravitation attraction.

In some examples, the camera is attached to an eyewear temple.

In some examples, the camera is configured to provide feedback if the output indicative of the direction of gravitation attraction is outside a threshold prior to capturing the image. In some examples, the feedback may include optical, auditory, vibrational feedback, or combinations thereof.

### BRIEF DESCRIPTION OF THE DRAWINGS

Features, aspects and attendant advantages of described embodiments will become apparent from the following detailed description, in which:

FIG. 1 illustrates a system arranged in accordance with examples described herein.

FIG. 2 illustrates a flow diagram of a process for automatic processing of an image captured by a camera in accordance with some examples herein.

FIG. 3 illustrates eyewear with an electronic wearable device in the form of a camera attached to a temple of the eyewear.

FIG. 4 is a schematic illustration of a first view of a camera arranged in accordance with examples described herein.

FIG. 5 is a schematic illustration of another view of the camera of FIG. 4 arranged in accordance with examples described herein.

FIG. 6 is a schematic illustration of another view of the camera of FIG. 4 arranged in accordance with examples described herein.

FIG. 7 is a schematic illustration of a camera attached to eyewear using a wedge arranged in accordance with examples described herein.

FIG. 8 illustrates a top down view of the eyewear temple, wedge, and camera of FIG. 7.

FIG. 9 is a schematic illustration of a camera attached to eyewear using a wedge arranged in accordance with examples described herein, where the temple is pointing temporally.

FIG. 10 is another view of the temple, camera, and wedge of FIG. 9.

FIG. 11 illustrates an example layout having regions corresponding to recommendations for different wedges.

FIG. 12 is a schematic illustration of a user positioning a computing system and a display of a computing system running a calibration application arranged in accordance with examples described herein.

FIG. 13 is a flowchart illustrating a training stage of an image adjustment technique utilizing machine learning arranged in accordance with examples described herein.

FIG. 14 is a flowchart illustrating an application stage of an image adjustment technique utilizing machine learning arranged in accordance with examples described herein.

FIG. 15 is a schematic illustration of a wearable device system including a blink sensor arranged in accordance with examples described herein.

FIG. 16 is a schematic illustration of a wearable camera and flash system arranged in accordance with examples described herein.

### DETAILED DESCRIPTION

Examples described herein include methods and systems for adjusting images which may be captured, for example, by a wearable camera. The wearable camera may be devoid of a viewfinder. Accordingly, it may be desirable to adjust images captured by the wearable camera prior to display to a user. Image adjustment techniques may employ physical wedges, calibration techniques, and/or machine learning techniques as described herein.

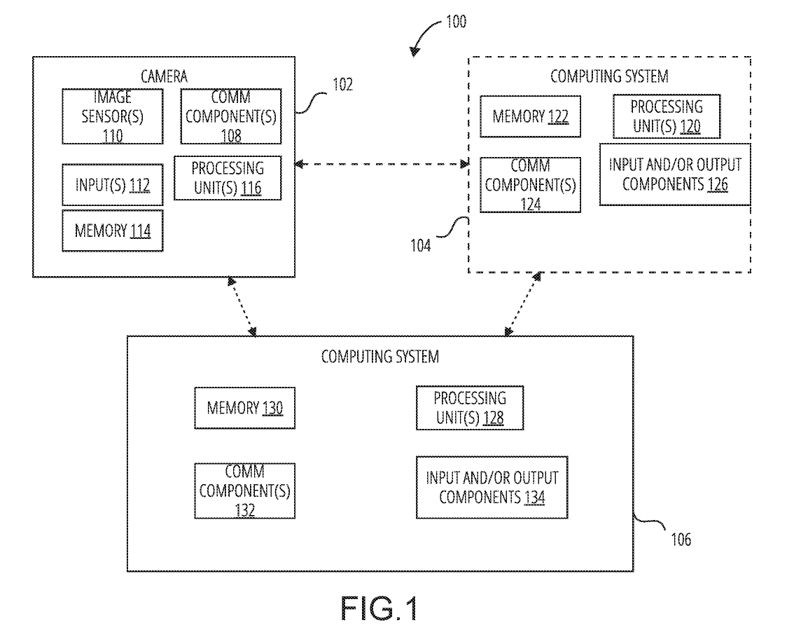

FIG. 1 illustrates a system arranged in accordance with examples described herein. The system 100 includes camera 102, computing system 104, and computing system 106. While two computing systems are shown in FIG. 1, generally any number may be present, including one, three, four, five, or more computing systems. Examples described herein include methods for manipulating (e.g., aligning, orienting) images captured by a camera. It is to be understood that the methods may be implemented using one or more computing systems, which may include computing system 104 and/or computing system 106.

Generally, any imaging device may be used to implement camera 102. Camera 102 may include image sensor(s) 110, comm component(s) 108, input(s) 112, memory 114, processing unit(s) 116, and/or any combination of those components. Other components may be included in other examples. Camera 102 may include a power source in some examples, or may be coupled to a wired or wireless power source in some examples. Camera 102 may include one or more communication components, comm component(s) 108, which may form a wired and/or wireless communication connection to one or more computing systems, such as computing system 104 and/or computing system 106. The comm component(s) 108 may include, for example, a Wi-Fi, Bluetooth, or other protocol receiver/transmitter and/or a USB, serial, HDMI, or other port. In some examples, the camera may be devoid of a view finder and/or display. Thus, the captured first image may not have been previewed prior to capture. This may be common or advantageous in the case of a body-worn camera. In some examples described herein, the camera 102 may be attached to eyeglasses of a user. In some examples, the camera 102 may be worn or carried by a user, including but not limited to, on or by a user's hand, neck, wrist, finger, head, shoulder, waist, leg, foot, ankle. In this manner, the camera 102 may not be positioned for a user to view a preview of an image captured by the camera 102. Accordingly, it may be desirable to process the image after capture to adjust the image, such as by adjusting an alignment (e.g., orientation) of the image or other image properties.

The camera 102 may include memory 114. The memory 114 may be implemented using any electronic memory, including but not limited to, RAM, ROM, Flash memory. Other types of memory may be used in other examples. In some examples, the memory 114 may store all or portions of images captured by image sensor(s) 110. In some examples, memory 114 may store settings which may be used by the image sensor(s) 110 to capture one or more images. In some example, the memory 114 may store executable instructions which may be executed by processing unit(s) 116 to perform all or portions of image adjustment techniques described herein.

The camera 102 may include processing unit(s) 116. The processing unit(s) 116 may be implemented using hardware able to implement processing described herein, such as one or more processor(s), one or more image processor(s), and/or custom circuitry (e.g., application-specific integrated circuits (ASICs), field programmable gate arrays (FPGAs)). The processing unit(s) 116 may be used to execute instructions which may be stored in memory 114 to perform some or all of the image adjustment techniques described herein.

In some examples, minimal processing may be performed by processing unit(s) 116 on camera 102. Instead, data representing images captured by image sensor(s) 110 may be transmitted, wirelessly or through a wired connection, using comm component(s) 108 to another computing system for further processing. In some examples the processing unit(s) 116 may perform compression and/or encryption of data representing images captured by image sensor(s) 110 prior to communicating the data to another computing system.

Camera 102 may include input(s) 112. For example, one or more buttons, dials, receivers, touch panels, microphones, or other input components may be provided which may receive one or more inputs for control of image sensor(s) 110. For example, input from input(s) 112 may be used to initiate the capture of an image using the image sensor(s) 110. A user may press a button, turn a dial, touch a touch panel, or perform an action which generates a wireless signal for a receiver, to initiate capture of an image using image sensor(s) 110. In some examples a same or different input may be used to initiate capture a video using image sensor(s) 110.

In some examples, one or more other output components may be provided in camera 102. For example, a display, a tactile output, a speaker, and/or a light may be provided. The outputs may indicate, for example, that image capture is planned and/or underway, or that video capture is planned and/or underway. While in some examples an image representative of the image to be captured by the image sensor(s) 110 may be displayed, in some examples no view finder or previewed image may be provided by camera 102 itself.

The computing system 104 may be implemented using generally any computing system, including but not limited to, a server computer, desktop computer, laptop computer, tablet, mobile phone, wearable device, automobile, aircraft, and/or appliance. In some examples, the computing system 104 may be implemented in a base unit, case, and/or adapter. The computing system 104 may include processing unit(s) 120, memory 122, comm component(s) 124, input and/or output components 126, or combinations thereof. Additional or fewer components may be used in other examples.

The comm component(s) 124 may form a wired and/or wireless communication connection to one or more cameras and/or computing systems, such as camera 102 and/or computing system 106. The comm component(s) 124 may include, for example, a Wi-Fi, Bluetooth, or other protocol receiver/transmitter and/or a USB, serial, HDMI, or other port. In some examples, the computing system 104 may be a base unit, case, and/or adapter which may connect to the camera 102. In some examples, the camera 102 may be physically supported by the computing system 104 (e.g., the camera 102 may be inserted into and/or placed on the computing system 104 during at least a portion of time connected with computing system 104).

The computing system 104 may include memory 122. The memory 122 may be implemented using any electronic memory, including but not limited to, RAM, ROM, Flash memory. Other types of memory or storage (e.g., disk drives, solid state drives, optical storage, magnetic storage) may be used in other examples. In some examples, the memory 122 may store all or portions of images captured by image sensor(s) 110. In some examples, memory 122 may store settings which may be used by the image sensor(s) 110 to capture one or more images. In some example, the memory 122 may store executable instructions which may be executed by processing unit(s) 120 to perform all or portions of image adjustment techniques described herein.

The computing system 104 may include processing unit(s) 120. The processing unit(s) 120 may be implemented using hardware able to implement processing described herein, such as one or more processor(s), one or more image processor(s), and/or custom circuitry (e.g., application-specific integrated circuits (ASICs), field programmable gate arrays (FPGAs)). The processing unit(s) 120 may be used to execute instructions which may be stored in memory 122 to perform some or all of the image adjustment techniques described herein.

The computing system 104 may include input and/or output components 126. For example, one or more buttons, dials, receivers, touch panels, microphones, keyboards, mice, or other input components may be provided which may receive one or more inputs for control of computing system 104. For example, input from input and/or output components 126 may be used to control adjustment of images as described herein—e.g., to provide parameters, feedback, or other input relevant for the adjustment of images. In some examples, one or more other output components may be provided in input and/or output components 126. For example, a display, a tactile output, a speaker, and/or a light may be provided. The outputs may display images before, during, and/or after image adjustment techniques described herein are performed.

The computing system 106 may be implemented using generally any computing system, including but not limited to, a server computer, desktop computer, laptop computer, tablet, mobile phone, wearable device, automobile, aircraft, and/or appliance. The computing system 106 may include processing unit(s) 128, memory 130, comm component(s) 132, input and/or output components 134, or combinations thereof. Additional or fewer components may be used in other examples.

The comm component(s) 132 may form a wired and/or wireless communication connection to one or more cameras and/or computing systems, such as camera 102 and/or computing system 104. The comm component(s) 132 may include, for example, a Wi-Fi, Bluetooth, or other protocol receiver/transmitter and/or a USB, serial, HDMI, or other port.

The computing system 106 may include memory 130. The memory 130 may be implemented using any electronic memory, including but not limited to, RAM, ROM, Flash memory. Other types of memory or storage (e.g., disk drives, solid state drives, optical storage, magnetic storage) may be used in other examples. In some examples, the memory 130 may store all or portions of images captured by image sensor(s) 110. In some examples, memory 130 may store settings which may be used by the image sensor(s) 110 to capture one or more images. In some example, the memory 130 may store executable instructions which may be executed by processing unit(s) 128 to perform all or portions of image adjustment techniques described herein. In some examples the memory 130 may store executable instructions which may be executed by processing unit(s) 128 for an application which may use and/or display one or more images described herein (e.g., a user image viewer, a communications application, such as an image storage, manipulation, sharing, other application).

The computing system 106 may include processing unit(s) 128. The processing unit(s) 128 may be implemented using hardware able to implement processing described herein, such as one or more processor(s), one or more image processor(s), and/or custom circuitry (e.g., application-specific integrated circuits (ASICs), field programmable gate arrays (FPGAs)). The processing unit(s) 128 may be used to execute instructions which may be stored in memory 130 to perform some or all of the image adjustment techniques described herein. In some examples the processing unit(s) 128 may be used to execute instructions which may be all or partially stored in memory 130 to provide an application for viewing, editing, sharing, or using images adjusted using techniques described herein.

The computing system 106 may include input and/or output components 134. For example, one or more buttons, dials, receivers, touch panels, microphones, keyboards, mice, or other input components may be provided which may receive one or more inputs for control of computing system 106. For example, input from input and/or output components 134 may be used to control adjustment of images as described herein—e.g., to provide parameters, feedback, or other input relevant for the adjustment of images. Input from input and/or output components 134 may be used to view, edit, display, select, or otherwise use images adjusted using techniques described herein. In some examples, one or more other output components may be provided in input and/or output components 134. For example, a display, a tactile output, a speaker, and/or a light may be provided. The outputs may display images before, during, and/or after image adjustment techniques described herein are performed.

It is to be understood that the division of processing operations between camera 102, computing system 104, computing system 106, and/or other computing systems which may be included in system 100 is quite flexible. In some examples, some or all of the techniques described herein for image adjustment may be performed by camera 102 itself, for example, using processing unit(s) 116 and memory 114. In some examples, images captured by image sensor(s) 110 may be communicated to computing system 104 and the computing system 104 may perform some or all of the techniques described herein for image adjustment. Data corresponding to adjusted images may be communicated from computing system 104 to computing system 106 for further manipulation and/or use by computing system 106. In some examples, the computing system 104 may not be present. Images captured by image sensor(s) 110 may be communicated to computing system 106 and the computing system 106 may perform some or all of the techniques described herein for image adjustment, for example using processing unit(s) 128 and memory 130.

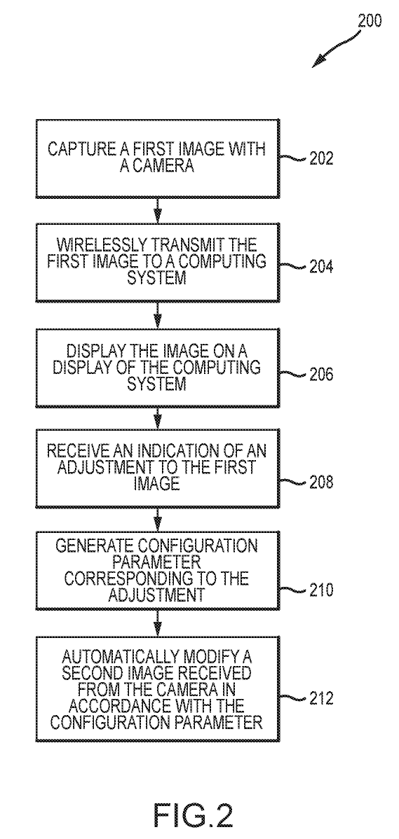

FIG. 2 is a flowchart of a method arranged in accordance with examples described herein. As shown in block 202 and block 204 of FIG. 2 a method 200 may include the steps of capturing a first image with a camera (e.g., camera 102 of FIG. 1), and transmitting the first image to a computing system (e.g., computing system 104 and/or computing system 106 in FIG. 1). Images may be transmitted from the camera to the computing system wirelessly or via a wired connection. An image may be transmitted automatically to the computing system after capture, or it may be temporarily stored onboard the camera's memory and transmitted at a later time, for example responsive to user input or upon the occurrence of another event (e.g., camera memory at full capacity, re-establishing communication with the computing system, etc.).

One or more images, such as a first image captured by a camera may be used as a set-up or reference image or set of images. The reference image(s) may be displayed on a display of the computing system (e.g., input and/or output components 126 of computing system 104), as shown in block 206 of FIG. 2. The user may modify the reference image(s), for example by changing the center of the image, or changing an orientation of the image. This user-directed modification to the reference image(s) may be received by the computing system as an indication of an adjustment to a location relative to the center of the first image or the orientation of the first image, as shown in block 208. While displaying the image and receiving an indication from a user modification is shown in blocks 206 and 208 of FIG. 2, in other examples, the image may not be displayed and/or manipulated by a user. In some examples, the computing system itself may analyze the image, which may not involve display of the system. The computing system may provide the indication of the adjustment. For example, an automated process operating on the computing system may analyze the image, using for example techniques described herein (e.g., machine learning, color recognition, pattern matching) and provide an indication of adjustment. In some examples, the adjustment to a location relative to the center may be an adjustment to the center of the image. In other examples, the adjustment to a location relative to the center may be an adjustment to a location other than the center (e.g., a peripheral location) which may be related to the center of the image. For example, a user may select a peripheral location spaced inward from the perimeter or boundary of the image and the auto-centering process may set the selected peripheral location as the new perimeter or boundary of the image and thereby adjust a center of the image. Other adjustments may be made to change a center of the image, such as by cropping in an off-center manner, enlarging a portion of the image, or others. A number of different techniques may be used to change the alignment (e.g., an orientation) of the image, such as by receiving user input corresponding to a degree rotation of the image, a selection of a location of the image (e.g., peripheral location) and amount of radial displacement of the location, and others. The computing system may generate settings (e.g. configuration parameters) corresponding to the adjustment, as shown in block 210 and store the configuration parameters in memory (e.g., memory 122). This may complete a configuration or set-up process. In subsequent steps, the user may capture additional images with the camera (e.g., camera 102). The images may be transmitted to the computing system (e.g., computing system 104 and/or computing system 106) for processing (e.g., batch processing). The computing system may retrieve the settings (e.g. configuration parameters) following receipt of a second image from the camera and may automatically modify the second image in accordance with the settings, as shown in block 212 in FIG. 2. For example, the computing system may automatically center or rotate the image by a corresponding amount as in the first image. This modification may be performed automatically (e.g., without further user input) and/or in batch upon receiving additional images from the camera, which may reduce subsequent processing steps that the user may need to perform to the images. In some examples, initial modification (e.g., as directed by user input) may include cropping the image, which may be reflected in the configuration parameter. Thus, in some examples, automatic modification of subsequent images may also include cropping a second image based on the configuration parameters. In some examples, the camera may be operable to be communicatively coupled to two or more computing systems. For example, the camera may be configured to receive power and data from and/or transfer data to a second computing system (e.g., computing system 106). In some examples, the first computing system may be configured to transmit (e.g., wirelessly) the configuration parameters to the camera. The configuration parameters may be stored in memory onboard the camera (e.g., memory 114) and may be transmitted to other computing devices different from the initial computing device which generated the configuration parameters. The configuration parameters may be transmitted to these other computing devices for example prior to or along with images transferred thereto, which may enable automatic processing/modification of images by additional computing device other than the computing device used in the initial set-up process. In some example, the auto-centering or auto-alignment of subsequent images in accordance with the configuration parameters may instead be performed by the camera, for example automatically after image capture. It will be appreciated that the designation of computing system as first or second is provided for clarity of illustrations and in examples, the set-up/configuration steps may be performed by the second computing system.

In some examples, a process for auto-centering of an image may include the steps of capturing an image with a camera (e.g., camera 102). The camera may be devoid of a view finder. The camera 102 may transmit, wirelessly or via a wired connection, the image to a computing system (e.g., computing system 104 and/or computing system 106). The computing system may include processor-executable instructions (e.g., stored in memory 122 and/or memory 130) for processing the image, for example for auto-centering the image based on a number of objects in the image. For example, the computing system may include processor-executable instructions for identifying number of objects in the image. In some examples, the objects may be one or more heads, which may be human heads, or other objects such as buildings, or other natural or man-made structures. Following identification of the number of objects, the computing system may determine a middle object from the number of objects. For example, if the computing system determines that there are 5 heads in the image, the middle head, which may be the 3^{rd} head, may be selected as the middle head, if the computing system determines that there are 7 heads, the 4^{th} head may be determined as the middle head, and so on. In some examples, the computing system may include instructions for centering the image between two adjacent object. For example, if an even number of objects are identified, the computing system may be configured to split the difference between the middle two adjacent object and center the image there. In some examples, the computing system may refer to a look-up table which may identify the middle object(s) for any given number of objects. The computing system may then automatically center the image on the middle object or a midpoint between two adjacent middle objects. In other words, the computing system may be configured to count the number of heads in the captured image and center the captured image on the middle head or the midpoint between two adjacent middle objects. The computing system may store the modified image centered in accordance with the examples herein.

Configuration parameters for a camera may be generated for multiple users or use cases. In some examples, the appropriate configuration parameter may be intelligently automatically applied to the camera as described further below. As described, a configuration parameter for the camera may include one or more configuration parameters for automatically centering and or orienting an image, which may collectively be referred to herein as auto-alignment parameters.

In some examples, a user may have different eyewear to which the camera may be attachable, or multiple users within a household may use the same camera. The relationship between the line of sight of the camera and the user's line of sight may change when the camera is moved from one eyewear to another eyewear or used by a different user (e.g., due to differences in eyewear design or eyewear fit). In some examples, attachment of the camera to the eyewear (e.g., via a guide) may provide the camera in a fixed orientation with respect to the temple. For simplicity and to attain a small form factor, the camera may not be provided with a means for modifying the orientation of the camera and more specifically the image capture device relative to the temple. In such examples, if a single configuration parameter or set of configuration parameters are applied across the multiple users or use cases, the auto-alignment parameters may be ineffective as different frames of the same user may position the camera differently with respect to a line of sight of the user or similarly, different users may have different sizes and geometries of frames thus again positioning the camera differently with respect to lines of sight of the different users. Also, as described, the camera may be devoid of a view finder and in such cases, the user may be unable to preview the image to be captured.

To address this, a plurality of configuration parameters or sets of configuration parameters may be generated. In one example, the camera may be configured to automatically apply the appropriate configuration parameter or set of configuration parameters. In other examples, the appropriate configuration parameter may be manually selected.

For example, a first set of parameters may be generated for the camera when the camera is attached to a first eyewear frame of a user, also referred to as first use case, and a second set of parameters may be generated for the camera when the camera is attached to a second eyewear frame of the user, also referred to as second use case, in accordance with the examples here (e.g., via first and second reference images captured through each use case). In similar manner, a third set of parameters may be generated for the camera when the camera is attached to an eyewear frame of another user, referred here as third use case. Each of the first, second, and third set of parameters may be stored onboard the camera (e.g., in memory 114 of camera 102) or stored remotely (e.g., in memory 122 of computing system 104) and be accessible to the camera (e.g., via a wireless and/or wired connection with the computing system 104).

The camera may be configured to automatically determine the appropriate set of parameters to be applied. In some examples, the camera may be configured to store all of the different sets, each of which may be associated with a user profile (e.g., first set of parameters associated with first user profile, second set of parameters associated with second user profile, and so on). The camera may be configured to receive user input (e.g., using one or more input(s) 112) to select the appropriate user. For example, the user may press a button of the camera to scroll through the available user profile (e.g., press once for the first user profile, press twice for the second user profile, and so on), or the user may speak or otherwise provide the user input to the camera. In other examples, the user input may be provided wirelessly via the user operating a user interface of a computing device (e.g., a mobile phone, or the computing device used to generate the parameters). In other examples, the camera may be configured to automatically determine the appropriate user profile by detecting a signature of the eyewear frame.

As an example, the image sensor of the camera may be used to capture an image of the frame or portion thereof, which may be processed to determine a visual characteristic of the frame (e.g., a color of the frame, a logo, or other) at the time of capture of the reference image. The configuration parameters for the reference image acquired with this eyewear frame may then be associated with the signature of the eyewear frame and/or stored therewith. Prior to subsequent use with the same or another frame, the image sensor may be directed to the frame or portion thereof (e.g., before the user attached the camera to the track, the user may point the camera towards the relevant portion of the frame) such that the camera may obtain the signature of the eyewear frame and determine which configuration parameters should be applied. In some examples, the camera may be configured to be attachable to either side of the eyewear (e.g., to the left temple or the right temple). This may be enabled by articulating features of the camera, such as a pivotable base which may enable re-orienting the camera such that it points forward regardless of which temple it is attached to. In such examples, the automatic determination of the appropriate user profile may be based on which temple the camera is attached to (e.g., the first user may use the camera on the left temple and thus the first set of parameters may be associated with the camera in the left temple configuration, while a second user may use the camera on the right temple and thus the second set of parameters may be associated with the camera in the right temple configuration). In yet further examples, the camera may not be pivotable but still usable on either side of the eyewear frame. In such instances, the image captured on one side would be upside down and the camera may be configured to detect an upside down image (e.g., by detecting that the sky is below the ground) and auto-rotate the image to correct an upside down image. This auto correction may be applied alternatively or in addition to auto-alignment parameters as described herein. It will be understood that selection of the appropriate auto-alignment parameters may be performed in accordance with one or any combination of the examples of the present disclosure.

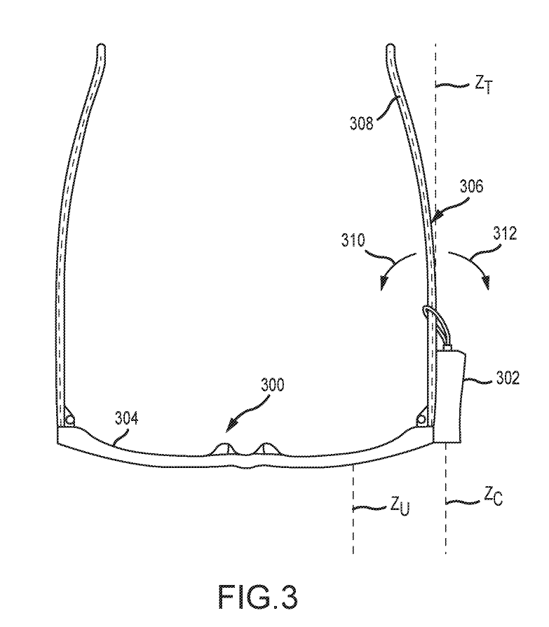

FIG. 3 shows an embodiment of a camera 302 attached to eyewear 300. The camera 302 may be magnetically attached to the eyewear 300, for example via magnetic attraction between a magnet or a ferro-magnetic material on the camera to a ferro-magnetic material or a magnet on the eyewear. In the particular example in FIG. 3, the camera 302 is attached to the eyewear frame 304 via a magnetic track 306 provided on the temple 308 of the eyewear 300.

The camera 302 has a line of sight, e.g., as indicated by line ZC, and the camera may be configured to attach to a wearable device (e.g., eyewear 300) in a manner which fixes the line of sight ZC of the camera relative to the wearable device. In some examples, the eyewear 300 may attach to the temple such that the camera's line of sight ZC is generally aligned with the longitudinal direction of the temple (e.g., ZT). In some cases, when the eyewear is worn, the user's line of sight ZU, may align with the line of sight of the camera ZC, as shown in FIG. 3. However, in some examples, when the eyewear is worn, the user's line of sight ZU, may not align with the line of sight of the camera ZC. For example, if the user's line of sight ZU is generally oriented straight ahead, the user line of sight may be oriented in a direction which is parallel to the nominal longitudinal direction of the temple, e.g., ZT. In such cases, the camera's line of sight may also align with the nominal longitudinal direction of the temple, e.g., ZT when the camera is moved forward for taking a picture and thus the camera's line of sight may align with the user's line of sight. If the temple is instead positioned inward or outward from the axis ZT such as indicated by arrow 310 and arrow 312. The camera's line of sight may not align with the user's line of sight. In such cases, a process for automatically aligning images in accordance with the examples herein may be used to address misalignment between the line of sight of the camera and the user's line of sight.

While camera 302 is shown in FIG. 3 connected to eyewear 300, in other examples, camera 302 may be carried by and/or connected to any other wearable item including, but not limited to a ring, a helmet, a necklace, a bracelet, a watch, a band, a belt, a body wear, a head wear, an ear wear, or a foot wear.

Camera 302 is shown in FIG. 3 having an attachment loop around the temple which may secure the camera 302 to the temple. The attachment loop may, for example, retain the camera 302 on the temple in the event camera 302 becomes otherwise disconnected from the temple. The attachment loop may not be present in other examples.

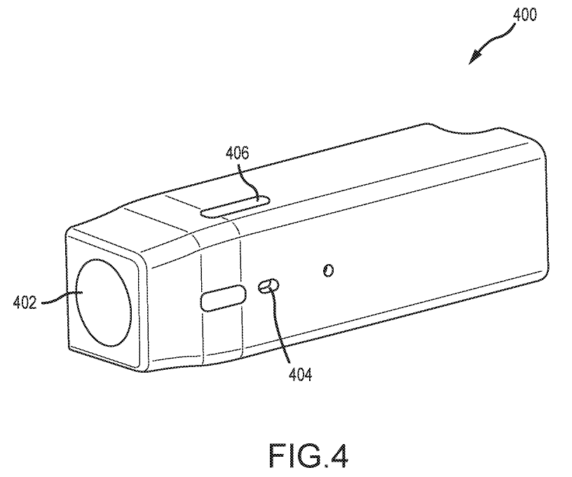

FIG. 4-FIG. 6 show views of a camera 400 in accordance with some examples of the present disclosure. The camera 400 may be used to implement and/or may be implemented by the camera 102 of FIG. 1 in some examples. The camera 400 may be configured to record audiovisual data. The camera 400 may include an image capture device, a battery, a receiver, a memory, and/or a processor (e.g. controller). The camera 400 may include an image sensor and an optical component (e.g., camera lens 402). The image capture device may be configured to capture a variety of visual data, such as image stills, video, etc. Thus, images or image data may interchangeably be used to refer to any images (including video) captured by the camera 400. In some examples, the camera 400 may be configured to record audio data. For example, the camera 400 may include a microphone 404 operatively coupled to the memory for storing audio detected by the microphone 404.

The camera 400 may include one or more processing unit(s) such as a controller, which may be implemented in hardware and/or software. For example, the controller may be implemented using one or more application specific integrated circuits (ASICs). In some examples, some or all of the functionality of the controller may be implemented in processor-executable instructions, which may be stored in memory onboard the camera. In some examples the camera may wirelessly receive instructions for performing certain functions of the camera, e.g., initiating image/video capture, initiating data transfer, setting parameters of the camera, adjusting images, and the like. The processor-executable instructions, when executed by a processing unit or units onboard the camera 400 may program the camera 400 to perform functions, as described herein. Any combination of hardware and/or software components may be used to implement the functionality of a camera according to the present disclosure (e.g., camera 400).

The camera 400 may include a battery. The battery may be a rechargeable battery such as a Nickel-Metal Hydride (NiMH), a Lithium ion (Li-ion), or a Lithium ion polymer (Li-ion polymer) battery. The battery may be operatively coupled to a receiver to store power received wirelessly from a distance separated wireless power transfer system. In some example, the battery may be coupled to energy generator (e.g., an energy harvesting device) onboard the camera. Energy harvesting devices may include, but are not limited to, kinetic-energy harvesting devices, solar cells, thermoelectric generators, or radio-frequency harvesting devices. In other examples, the camera may instead be charged via a wired connection. To that end, the camera 400 may be equipped with an input/output connector (e.g., a USB connector such as USB connector 502) for charging a battery of the camera from an external power source and/or for providing power to components of the camera and/or for providing data transfer to/from the camera. The term USB as used herein may refer to any type of USB interface including micro USB connectors.

In some examples, the memory of the camera may store processor-executable instructions for performing functions of the camera described herein. In such examples, a micro-processor may be operatively coupled to the memory and configured to execute the processor-executable instruction to cause the camera to perform functions, such as cause images to be captured upon receiving an image capture command, cause images to be stored in the memory, and/or cause images to be adjusted. In some examples, the memory may be configured to store user data including image data (e.g., images captured with the camera 400). In some examples, the user data may include configuration parameters. Although certain electronic components, such as the memory and processor are discussed in the singular, it will be understood that the camera may include any number of memory devices and any number of processors and other appropriately configured electronic components.

The memory and processor may be connected to a main circuit board (e.g., main PCB). The main circuit board may support one or more additional components, such as a wireless communication device (e.g., a Wi-Fi or Bluetooth chip), microphone and associated circuitry, and others. In some examples, one or more of these components may be supported by separate circuit boards (e.g., auxiliary board) operatively coupled to the main circuit board. In some examples, some of the functionality of the camera may be incorporated in a plurality of separate IC chips or integrated into a single processing unit.

The electronic components of camera 400 may be packaged in a housing 504 which may be made from a variety of rigid plastic materials known in the consumer electronics industry. In some examples, a thickness of the camera housing 504 may range from about 0.3 mm to about 1 mm. In some examples, the thickness may be about 0.5 mm. In some examples, the thickness may exceed 1 mm. A camera according to the present disclosure may be a miniaturized self-contained electronic device, e.g., a miniaturized point-and-shoot camera. The camera 400 may have a length of about 8 mm to about 50 mm. In some examples, the camera 400 may have a length from about 12 mm to about 42 mm. In some examples, the camera 400 may have a length not exceeding 42 mm. In some examples the camera 400 may be about 12 mm long. The camera 400 may have a width of about 8 mm to about 12 mm. In some examples, the camera 400 may be about 9 mm wide. In some example, the camera 400 may have a width not exceeding about 10 mm. In some examples, the camera 400 may have a height of about 8 mm to about 15 mm. In some examples, the camera 400 may be about 9 mm high. In some examples, the camera 400 may have a height not exceeding about 14 mm. In some examples, the camera 400 may weigh from about 5 grams to about 10 grams. In some examples the camera 400 may weigh about 7 grams or less. In some examples, the camera 400 may have a volume of about 6,000 cubic millimeters or less. In some examples, the camera 400 may be a waterproof camera. In some examples, the camera may include a compliant material, e.g., forming or coating at least a portion of an exterior surface of the camera 400. This may provide functionality (e.g., accessibility to buttons through a waterproof enclosure) and/or comfort to the user.

The electronic components may be connected to the one or more circuit boards (e.g., main PCB and auxiliary circuit board) and electrical connection between the boards and/or components thereon may be formed using known techniques. In some examples, circuitry may be provided on a flexible circuit board, or a shaped circuit board, such as to optimize the use of space and enable packaging of the camera within a small form factor. For example, a molded interconnect device may be used to provide connectivity between one or more electronic components on the one or more boards. The electronic components may be stacked and/or arranged within the housing for optimal fit within a miniaturized enclosure. For example, the main circuit board may be provided adjacent another component (e.g., the battery) and attached thereto via an adhesive layer. In some examples, the main PCB may support IC chips on both sides of the board in which case the adhesive layer may attach to packaging of the IC chips, a surface of a spacing structure provided on the main PCB and/or a surface of the main PCB. In other examples, the main PCB and other circuit boards may be attached via other conventional mechanical means, such as fasteners.

In some examples, the camera 400 may be waterproof. The housing 504 may provide a waterproof enclosure for the internal electronics (e.g., the image capture device, battery, and circuitry). After the internal components are assembled into the housing 504, a cover may be irremovably attached, such as via gluing or laser welding, for example. In some examples, the cover may be removable (e.g., for replacement of the battery and/or servicing of the internal electronics) and may include one or more seals.

In some examples, the housing 504 may include one or more openings for optically and/or acoustically coupling internal components to the ambiance. In some examples, the camera may include a first opening on a front side of the camera. An optically transparent (or nearly optically transparent) material may be provided across the first opening thereby defining a camera window for the image capture device. The camera window may be sealingly integrated with the housing, for example by an overmolding process in which the optically transparent material is overmolded with the plastic material forming the housing. The image capture device may be positioned behind the camera window with the lens 402 of the image capture device facing forward through the optically transparent material. In some examples, an alignment or orientation of the image capture device may be adjustable.

A second opening may be provided along a sidewall of the housing 504. The second opening may be arranged to acoustically couple the microphone 404 with the ambiance. A substantially acoustically transparent material may be provided across the second opening to serve as a microphone protector plug (e.g., to protect the microphone from being soiled or damaged by water or debris) without substantially interfering with the operation of the microphone. The acoustically transparent material may be configured to prevent or reduce water ingress through the second opening. For example, the acoustically transparent material may comprise a water impermeable mesh. The mesh may be a micro-mesh sized with a mesh density selected to prevent water from passing through the mesh. In some examples, the mesh may include (e.g., formed of, or coated with) an hydrophobic material.

The microphone 404 may be configured to detect sounds, such as audible commands, which may be used to control certain operations of the camera 400. In some examples, the camera 400 may be configured to capture an image responsive to an audible command. In some examples, the audible command may be a spoken word or it may be a non-speech sound such as the click of teeth, the click of a tongue, or smack of lips. The camera 400 may detect the audible command (e.g., in the form of an audible sound) and perform an action, such as capture an image, adjust an image, transfer data, or others.

In some examples, the camera 400 may be configured to transfer data wirelessly and/or through a wired connection to another electronic device, for example a base unit or other computing system. For example, the camera 400 may transfer all or portions of images captured by the image capture device for processing and/or storage elsewhere such as on the base unit and/or another computing device (e.g., personal computer, laptop, mobile phone, tablet, or a remote storage device such as cloud storage). Images captured with the camera 400 may be processed (e.g., batch processed) by the other computing device. Data may be transferred from the camera 400 to the other electronic device (e.g., base unit, a personal computing device, the cloud) via a separate wireless communication device (e.g., Wi-Fi or Bluetooth enabled device) or via the receiver/transmitter of the camera 400, which in such instances would be configured to also transmit signals in addition to receiving signals (e.g., power signals). In other words, in some examples, the receiver may in some examples be also configured as a transmitter such that the receiver is operable in transmit mode as well as receive mode. In some examples, data (e.g., images) may be transferred from the camera 400 to another computing device via a wired connection (e.g., USB connector 502).

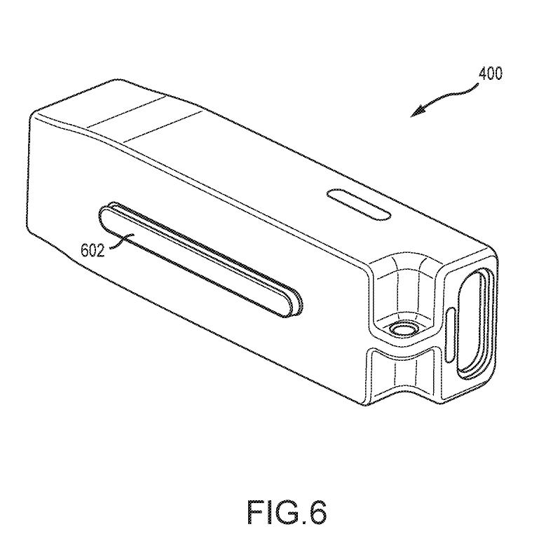

The camera 400 may be a wearable camera. In this regard the camera 400 may be configured to be attached to a wearable article, such as eyewear. In some examples, the camera may be removably attached to a wearable article. That is, the camera may be attachable to the wearable article (e.g., eyewear), detachable from the wearable article (e.g., eyewear), and may be further configured to be movable on the wearable article while attached thereto. In some examples, the wearable article may be any article worn by a user, such as by way of example only, a ring, a band (e.g., armband, wrist band, etc.), a bracelet, a necklace, a hat or other headgear, a belt, a purse strap, a holster, or others. The term eyewear includes all types of eyewear, including and without limitation eyeglasses, safety and sports eyewear such as goggles, or any other type of aesthetic, prescription, or safety eyewear. In some examples, the camera 400 may be configured to be movably attached to a wearable article, such as eyewear, for example via a guide 602 (as shown in FIG. 6) configured to engage a corresponding guide on the eyewear, e.g., a track. The guide 602 on the camera may be configured to slidably engage the guide on the eyewear. In some examples, the guide on the eyewear may be provided on the eyewear frame, e.g., on a temple of the eyewear. The camera 400 may be configured to be attachable, detachable, and re-attachable to the eyewear frame. In some examples, the guide 602 may be configured for magnetically attaching the camera 400 to the eyewear. In this regard, one or more magnets may be embedded in the guide 602. The guide 602 may be provided along a bottom side (also referred to as a base) of the camera 400. The guide 602 may be implemented as a protrusion (also referred to as male rail or simply rail) which is configured for a cooperating sliding fit with a groove (also referred to as female track or simply track) on the eyewear. The one or more magnets may be provided on the protrusion or at other location(s) along the side of the camera including the guide 602. The eyewear may include a metallic material (e.g., along a temple of the eyewear) for magnetically attracting the one or more magnets on the camera. The camera may be configured to couple to the eyewear in accordance with any of the examples described in U.S. patent application Ser. No. 14/816,995, filed Aug. 3, 2015, and titled “WEARABLE CAMERA SYSTEMS AND APPARATUS AND METHOD FOR ATTACHING CAMERA SYSTEMS OR OTHER ELECTRONIC DEVICE TO WEARABLE ARTICLE.” which application is incorporated herein in its entirety for any purpose.

The camera 400 may have one or more inputs, such as buttons, for receipt of input from a user. For example, the camera 400 may have button 406 positioned on a surface of housing 504. The camera may include any number of inputs, such as buttons. The camera 400 further includes button 506. The button 406 and button 506 are positioned on opposite faces of the housing 504 such that, during wear, when the guide 602 is coupled to eyewear the button 406 and button 506 are positioned on upper and bottommost surfaces of the camera 400. Depressing the button, or a pattern of button activations, may provide commands and/or feedback to the camera 400. For example, depressing one button may trigger the camera 400 to capture an image. Depressing another button may trigger the camera 400 to begin to capture a video. Subsequently depressing the button may stop the video capture.

In some examples, when a camera is attached to a wearable device, such as an eyewear temple, the camera may itself not be aligned with a user's view. Examples described herein may include a wedge which may position a camera with respect to an eyewear temple (or other wearable device) such that the camera has a particular orientation (e.g. parallel) with a user's view. The male rail may attach to a groove in an eyewear temple. The wedge may be thicker at a forward or rear portion of the camera along the temple, which may orient the camera outward or inward. Wedges described herein may be made from a variety of materials including, but not limited to, rubber, wood, plastic, metal, or a combination of plastic and metal.

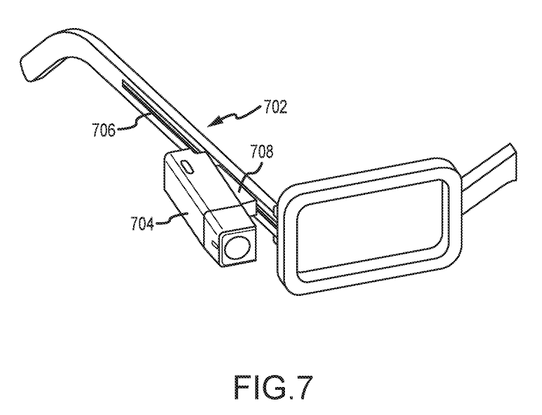

FIG. 7 is a schematic illustration of a camera attached to eyewear using a wedge arranged in accordance with examples described herein. FIG. 7 includes eyewear temple 702, camera 704, track 706, and wedge 708. In the example of FIG. 7, the eyewear temple 702 is pointing nasally. Accordingly, the wedge 708 has a thicker portion toward the front of the camera.

The camera 704 may be implemented using generally any camera described herein, including camera 102 and/or camera 400. Track 706 may be provided in eyewear temple 702. The track 706 may, for example, be a groove in the eyewear temple 702. The track 706 may include one or more magnet(s), metallic material, and/or ferromagnetic material in some examples. The track may be positioned on an outside of the temple in some examples. In some examples, the track may be positioned on an inside of the temple.

The wedge 708 may include a male rail for connection to the track 706 in some examples. The male rail may include one or more magnets. The wedge 708 may attach to a bottom of camera 704 in some examples. The wedge 708 may include a magnet associated with its base for magnetic attraction to track 706 using a magnet, ferromagnetic material, metal tape, or magnet attracting metal disposed in the track 706.

A wedge may be positioned between a camera and an eyewear temple in accordance with examples described herein. The wedge 708 may be attached to the camera 704 in a variety of ways. In some examples, the wedge 708 may be integral with the camera 704. In some examples, the wedge 708 may be removable from the camera. In some examples, the wedge 708 may be integral with another structure placed between the camera 704 and the eyewear temple. In some examples, the wedge 708 may include a magnet and the camera 704 may include a magnet. A magnet of the camera 704 may attach to one side of wedge 708 while a magnet of the wedge 708 may attach to the track 706. The attraction of the magnet of the camera to the wedge may be stronger than an attraction between the magnet of the wedge 708 and the track 706. In this manner, the camera 704 may be moved along the track 706 during operation while remaining connected to the wedge 708.

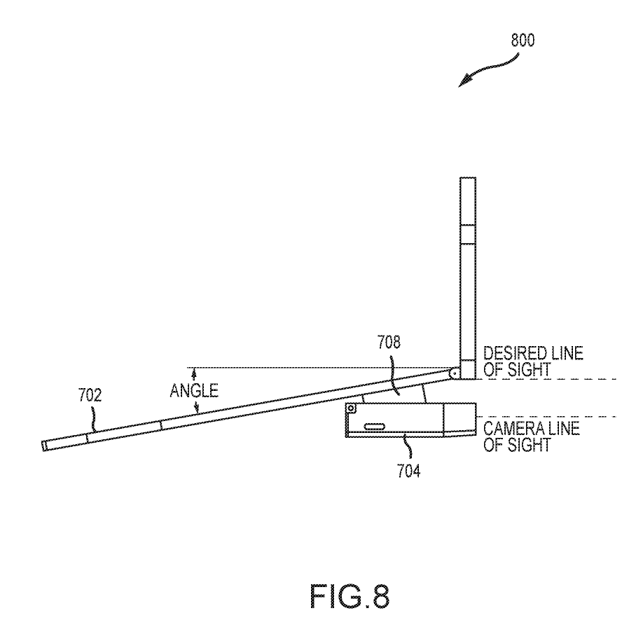

FIG. 8 provides a top down schematic view of the eyewear temple, wedge, and camera of FIG. 7. The eyewear temple 702 is oriented nasally, forming an angle as shown with a desired line of sight of a user (e.g. straight forward, generally perpendicular to the eyewear lenses). Without the aid of a wedge, the straight camera would be angled in at a different angle than the desired line of sight. The wedge 708 adjusts the camera 704 such that the camera's line of sight is generally parallel with a desired line of sight.

Accordingly, in some examples, an angle of the wedge may be selected such that it positions a camera's line of sight parallel with a desired line of sight. In some examples, the angle of the wedge may be equal to an angle between an eyewear temple and a desired line of sight. When the temple is oriented in nasally, as shown in FIG. 7 and FIG. 8, a thicker portion of the wedge 708 may be positioned toward a forward portion of the camera (e.g. toward a forward potion of the eyewear temple).

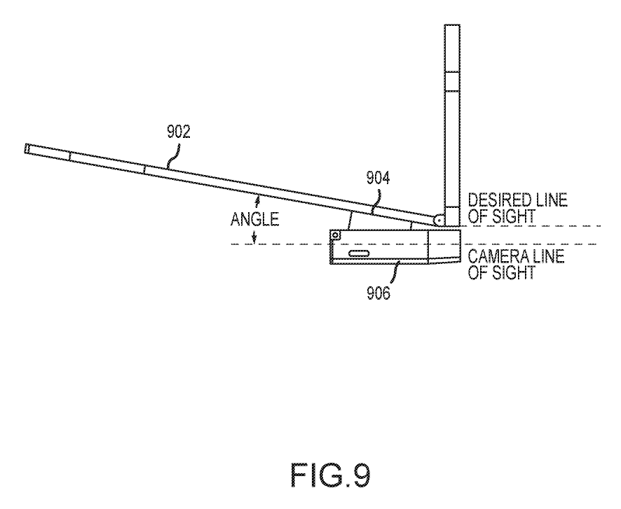

FIG. 9 is a schematic illustration of a camera attached to eyewear using a wedge arranged in accordance with examples described herein, where the temple is pointing temporally. FIG. 9 includes temple 902, wedge 904, and camera 906. The components of FIG. 9 are analogous to those described with respect to FIG. 7 and FIG. 8, except in FIG. 9, the temple 902 is pointing temporally.

Accordingly, the wedge 904 provided has a thicker portion of the wedge positioned toward a rear portion of the camera (e.g. toward a rear portion of the temple 902). This allows the camera line of sight to align parallel to the desired line of sight.

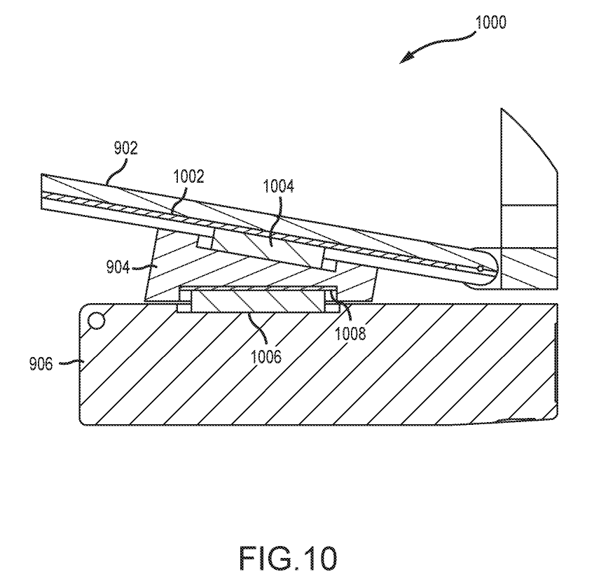

FIG. 10 is another view of the temple, camera, and wedge of FIG. 9. FIG. 10 illustrates a connection between the track 1002 of the temple 902, the wedge 904, and the camera 906.

The wedge 904 includes magnet 1004 associated with a base of wedge 904. Camera 906 includes a magnet 1006 associated with its base. The magnet 1006 may attach to one side of the wedge 904, which may have a magnet attracting metal 1008 or other material positioned to couple to magnet 1006. The magnet 1004 attaches to the track 1002 of the temple 902.

In some examples, the wedge 904 at least partially defines a cavity to receive the magnet 1006. The magnet 1006 may fit within the cavity of the wedge. The magnet 1006 may attach to a metal 1008, which may be a ferromagnetic metal, located within and/or partially defining the wedge cavity. The wedge 904 and/or metal 1008 may define a cavity having a floor and walls. The walls may surround the magnet 1006 on three sides in some examples. The attraction of magnet 1006 to the wedge 904 (e.g. to the metal 1008) may be stronger than the attraction of magnet 1004 to the track 1002. In this manner, the camera 906 may be removed from the track 1002 without necessarily being removed from the wedge 904. The magnet 1006 may be longer than magnet 1004 to facilitate a stronger attraction between magnet 1006 and metal 1008 than between magnet 1004 and track 1002 in some examples.

The camera 906 can be moved forward or backward along the track 1002 while remaining attached to the track in some examples. The remote display screen can inform the user if a wedge is required for attaching the camera to the track. The display screen can inform which wedge design is required. The display screen can inform if the thickest end of the wedge should be pointed forward or backward.

Examples described herein include methods and systems for determining if a wedge, such as wedge 708 and/or wedge 904 may be advantageous in aligning images. The methods or systems in some examples may identify a wedge design (e.g. angle of a wedge) and/or whether the thickest end of the wedge should be positioned forward or backward along the temple. Referring back to FIG. 1, the computing system 104 and/or computing system 106 may be programmed or otherwise configured to determine if a wedge, and which wedge, may be advantageous in some examples.

To determine if a wedge may be advantageous, an image may be captured with a camera (e.g. the camera 102 or another camera described herein). Data representative of the image may be provided to a computing system for display (e.g. the computing system 104 and/or computing system 106 of FIG. 1). The image may be displayed on a display overlaid on a scaled off layout. That is an image may be displayed over a layout indicating regions corresponding to a recommendation for particular wedges.

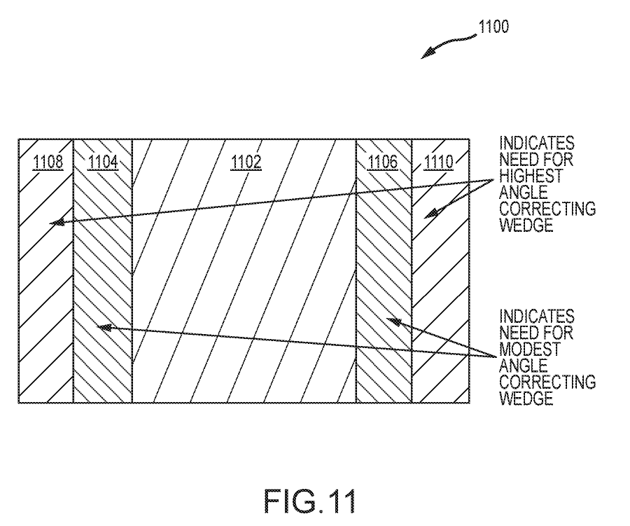

FIG. 11 illustrates an example layout having regions corresponding to recommendations for different wedges. The layout illustrated in FIG. 11 may be displayed on a display of computing system 104 and/or computing system 106 for example. An image captured by the camera 102 may be displayed simultaneously (e.g. superimposed on or behind) with the layout shown in FIG. 11.

A user may view the image and the layout and identify an intended central feature of the image. If the central feature appears in region 1102, no wedge may be recommended, as the intended central features may already be centered and/or may be within a range of center that may be adjusted by image adjustment techniques described herein (e.g. auto-rotate, auto-center, auto-alignment, auto-crop).

If the central feature of the image appears in region 1104 and/or region 1106, a wedge having an angle may be recommended. If the central feature of the image appears in region 1108 and/or region 1110, a wedge having another angle may be recommended. The angle recommended in connection with region 1108 and region 1110 may be larger than the angle recommended in connection with region 1104 and region 1106, because the central feature of the image has been captured further from the center of the camera's field of view. While the layout shown in FIG. 11 pertains to possible recommendation between two angles of wedges, any number may be used in other examples.

Moreover, if the central feature of the image appears in region 1108 or region 1104, one orientation of the thickest portion of the wedge may be recommended (e.g., toward a front of the temple). If the central feature of the image appears in region 1106 or region 1110, another orientation of the thickest portion of the wedge may be recommended (e.g., toward a rear of the temple). The opposite recommendation may be made if the camera is positioned on an opposite temple (e.g., left versus right temple).

Accordingly, a layout may be displayed together with a captured image. An angle of a recommended wedge may be selected based on a distance between the center of the captured image and an intended central feature of the image. For example, a further distance may result in a larger recommended wedge angle. An orientation of recommended wedge (e.g., which direction the thickest portion of the wedge should be positioned), may be based on which side of the center of the captured image the intended central feature appeared.

The layout may be depicted using any of a variety of delineations and shading, including colors, lines, etc. An indication of wedge angle and orientation may be displayed to a user on the display responsive to the user providing an indication of the central region of the image (e.g., by clicking or touching on the central region of the image).

While the example has been described with reference to a user viewing the image and identifying an intended central feature of the image, in some examples, a computing system may be programmed to identify the central feature of the image (e.g. by counting heads and selecting a central head). Responsive to the computing systems' indication of a central region, the computing system itself may provide a recommendation regarding the size and orientation of wedge without input from a user regarding the intended central region.

Responsive to a computing system providing a recommendation (e.g., by displaying a recommendation and/or transmitting the recommendation to another application or device) regarding a size and orientation of wedge, a user may add the recommended wedge to the camera and/or temple.

After adding the wedge, the user may capture images which may be adjusted using techniques described herein, e.g., using auto-centering, auto-rotation correction, auto-alignment, and/or auto-cropping.

Some examples of image adjustment techniques described herein may utilize one or more images of machine-readable symbols to provide metrics regarding image adjustment and/or facilitate image adjustment. Referring back to FIG. 1, the computing system 106 may run a calibration application (e.g. using computer executable instructions stored on memory 130 and executed by processing unit(s) 128) for reading one or more machine-readable symbols and providing metrics regarding image adjustment. The metrics regarding image adjustment may themselves be, or the metrics regarding image adjustment may be used to develop, settings for the camera 102 which may, for example be stored in memory 114 and/or memory 130. The metrics regarding image adjustment may include metrics regarding camera alignment, camera centering, camera rotation, cropping amount, or combinations or subsets thereof. In some examples, other metrics may additionally or instead be used. The application running on computing system 106 may adjust images captured with the camera 102 based on the metrics determined through the analysis of one or more images of machine-readable symbols. The adjustments may be alignment, centering, rotation, and/or cropping. Other adjustments may be made in other examples.

During operation, a calibration application running on the computing system 106 may prompt a user to carry and/or wear the camera 102. For example, the computing system 106 may display instructions to a user to attach their camera 102 to eyewear, and wear the eyewear. In other examples, the calibration application on the computing system 106 may provide audible instructions to a user to carry and/or wear the camera 102.

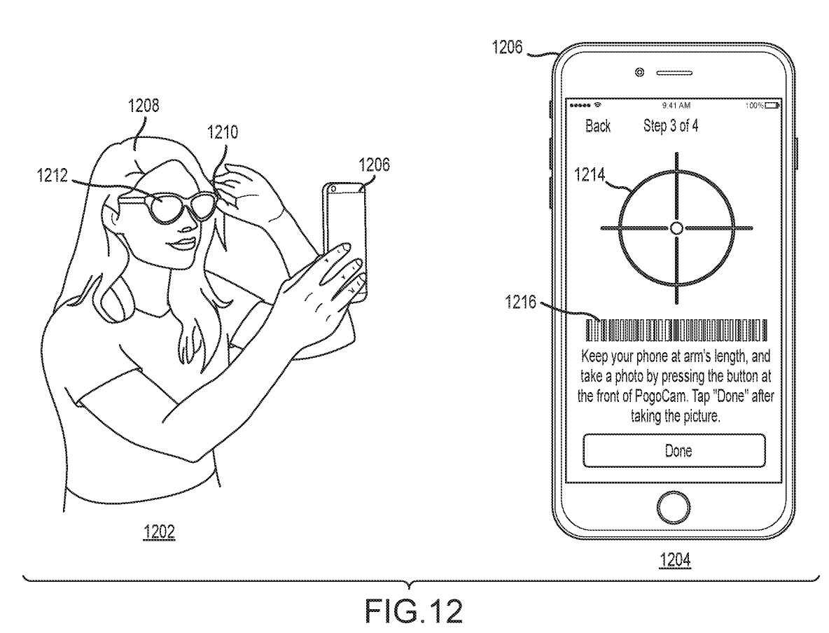

FIG. 12 is a schematic illustration of a user positioning a computing system and a display of a computing system running a calibration application arranged in accordance with examples described herein. FIG. 12 illustrates position 1202 and display 1204. Shown in position 1202 is computing system 1206, user 1208, camera 1210, and eyewear 1212. The computing system 1206 may be implemented and/or may be implemented by, computing system 106 of FIG. 1 in some examples. The computing system 1206 may run a calibration application. The camera 1210 may be implemented by and/or used to implement camera 102 of FIG. 1 and/or other camera(s) described herein. The camera 1210 may be a body-worn camera as described herein.

The calibration application running on computing system 1206 may prompt a user to adopt a particular position, such as position 1202. The calibration application may prompt a user to hold, position, and/or carry one or more machine-readable symbols in a particular way or in a particular position. For example, the user may be instructed (e.g. through a graphical display and/or audible instructions) to hold machine-readable symbols in front of them with one hand. Other positions may be used in some examples—e.g., the machine-readable symbols may be held to a left, right, up, or down, of center. The machine-readable symbols may be displayed in some examples on a display of computing system 1206, and the user may be instructed to hold the display of computing system 1206 in the particular position (e.g., directly in front of the user, as shown in FIG. 12). In other examples, the machine-readable symbols may be printed on a sheet, hung on a wall, or otherwise displayed and held or brought within range of the camera 1210.

The machine-readable symbols may include, for example, grids, bar codes, QR codes, lines, dots, or other structures which may facilitate the gathering of adjustment metrics.

Display 1204 is shown in FIG. 12 displaying examples of machine-readable symbols including machine-readable symbol 1214 and machine-readable symbol 1216. The machine-readable symbol 1214 includes a central dot, four quadrant lines, and a circle having the dot disposed in the center. The machine-readable symbol 1216 includes a bar code.

The user 1208 may take a picture of the machine-readable symbols, such as machine-readable symbol 1216 and/or machine-readable symbol 1214 using camera 1210. The picture may be taken, e.g., by providing an input to the camera 1210 through a button, audible command, wireless command, or other command in other examples. When an input to the camera is provided with a hand, generally one hand may be used to initiate the image capture while the other hand may hold the displayed machine-readable symbols.

Data representing an image of the machine-readable symbols may be stored at the camera 1210 and/or may be transmitted to the computing system 1206 (e.g., using a wired or wireless connection). For example, the user 1208 may connect the computing system 1206 to the camera 1210 using a USB connection.

The computing system 1206 (and/or another computing system) may analyze the image of the machine-readable symbols to provide metrics regarding camera alignment, camera centering, camera rotation, and/or cropping amount. Other metrics may be used in other examples. For example, the calibration application running on the computing system 1206 may determine one or more settings which specify an amount of rotation, shift, and/or cropping to a captured image which may result in a captured image oriented and/or aligned in a desired direction (e.g. commensurate with a user's field of view). The computing system 1206 may analyze the captured image of the machine-readable symbols and may determine an amount of rotation, shift, and/or cropping to center the machine-readable symbols in the image and orient them as shown on display 1204. Whether the image should be flipped (e.g. top-to-bottom) may be determined based on a relative position of the dot in the captured frame. If the dot was displayed in an upper portion of the display 1204, but appears in a lower portion of the captured image, the image may need to be flipped. The settings may be stored in the computing system 1206 and/or camera 1210 and may be used by the camera 1210 and/or computing system 1206 to manipulate subsequently taken images.

In some examples, where adjustments greater than a threshold amount may be desired based on analysis of the captured machine-readable symbols, the calibration application may display a recommendation to connect a wedge to the camera 1210. Any examples of wedges described herein may be used in some examples.

In some examples, the calibration application may prompt a user for one or more inputs relevant to the calibration procedure. For example, the calibration application may prompt a user to identify which temple (e.g., left or right) of eyewear is attached to the camera 1210.

Referring again to FIG. 1, examples of image adjustment techniques are described herein which may be performed using the system 100. Examples of image adjustment techniques may provide, e.g., auto-alignment, auto-rotation correction, and/or auto-cropping and may be implemented through firmware and/or software. The firmware and/or software for image adjustment may be deployed in some examples in memory 114 (e.g., flash memory and/or random access memory) which may be incorporated, e.g., in an image processing chip in camera 102. The firmware and/or software for image adjustment may be deployed in a stand-alone unit (e.g., computing system 104) which may download images from the camera 102. The computing system 104 may include an image processing chip (which may be used to implement processing unit(s) 120) and memory 122 which may be used to store images, process them, and store adjusted images. The stored adjusted images may be transmitted to another computing system, such as computing system 106, which may be implemented using, for example, a smart phone, a tablet or any other device. The computing system 106 may be connected to a wireless server or a Bluetooth receiver.

In some examples, the camera 102 may include one or more sensor(s) which may be used in image adjustment techniques described herein. One or more sensor(s) may be provided which may output a direction of gravitational attraction, which may provide a reference axis for rotational alignment of images. Example sensors include, but are not limited to, an accelerometer (e.g., g sensor). Such an accelerometer may comprise, by way of example only, a gyro sensor (e.g., a micro-gyroscope), a capacitive accelerometer, a piezo-resistive accelerometer, or the like. In some examples, the sensor may be mounted inside a microcontroller unit (e.g., which may be used to implement processing unit(s) 116). The output from the g sensor may be utilized by the camera 102, e.g., by firmware embedded in memory (e.g., memory 114) which may be included in the microcontroller unit of the camera module to flip or rotate images. For example, if the output from the sensor indicates that the camera is upside down relative to gravity, the camera 102 may be programmed to flip a captured image. If the output from the sensor indicates that the camera is right side up relative to gravity, the camera 102 may be programmed not to flip a captured image. In some examples, an output from the sensor may indicate a number of degrees from which the camera is oriented from a pre-established degree meridian (e.g., 0 degree vertical).

In some examples, an image orientation shift or relocation of any number of degrees from what was originally captured by the user can be implemented by the software and/or firmware described herein. The orientation can be determined according to a degree shift from that of the horizontal 180 degree meridian, from that of the vertical 90 degree meridian or an oblique meridian. This may allow for correcting what would appear to be a tilt of the image of the main scene or object in the main scene being captured. Following this correction, shift or adjustment the image should appear erect and oriented properly relative to, by way of example only the 90 degree vertical meridian. Being able to accomplish this image orientation correction may be desirable when using a wearable camera, and may be particularly desirable for a wearable camera without a view finder.

In some examples, the camera 102 may be programmed such that the camera 102 may be prevented from capturing an image if the image sensor(s) 110 and/or camera 102 are oriented greater than a threshold number of degrees away from the pre-established degree meridian, as indicated by the sensor. For example, when the sensor indicates that the image sensor(s) 110 and/or camera 102 are oriented greater than a threshold number of degrees away from the pre-established degree meridian, the image sensor(s) 110 may not capture an image responsive to an input which may otherwise cause an image to be captured. Instead, the camera 102 may provide an indication (e.g., a light, sound, and/or tactile responsive) indicating misalignment.

In some examples, some image adjustment may be performed by camera 102 and/or no image adjustment may be performed by camera 102 and further adjustment may be performed in computing system 104, which may be an external unit or a case that may be provided to store the camera 102 when not in use. Such a camera case may include an electronic control system comprising image processing firmware that may provide image alignment. In some examples, such as for wearable cameras that do not require an external unit for operational support, the image adjustment may be performed by computing system 106, e.g., using a smartphone app and/or as an image processing program in a tablet or laptop.

Image adjustment techniques which may be implemented may include rotational and translational alignment, color balancing, noise reduction through application of filters implemented in firmware and/or software (e.g., in addition to electronic filters that may be included in the design of an electronic signal processing chip), which may improve image quality under moderate or low light conditions. Examples may include subpixel processing to improve image resolution, and/or addition of blur functions to improve image quality (e.g., Gaussian blur). Examples of image adjustment techniques include image rotation, image centering, image cropping, face recognition, development of true color and false color images, image synthesis including image stitching to enhance field of view, increase depth of field, add three dimensional perspective, and other types of image quality improvements.

Generally, processing requirements for image adjustment techniques described herein may be compact to reduce a size impact on camera 102 and/or computing system 104 when the techniques are implement in those components. In some examples, image adjustment techniques may be of ultralow energy design, since an embedded battery or any other source of energy, including without limitation, micro-fuel cells, thermoelectric converters, super capacitors, photovoltaic modules, radio thermal units (e.g., units that generate electric power from heat emitted by radio isotopes through alpha or beta decay) which may be used in camera 102 and/or computing system 104 may also be desirably as compact as possible. In some examples, a practical limitation of rechargeable batteries embedded in the camera 102 may be 1 watt hour in total energy capacity of which 50% may be used on a repeated basis before recharging is required, while computing system 104 either associated or tethered to camera 102 may have no more than 5 watt hours of total energy capacity in some examples.

Image adjustment techniques described herein may desirably provide images for display to a user only after the image adjustment has been completed in some examples. A user may opt to process images further using software, e.g. in computing system 106, such as in a tablet or a smart phone, but for routine use, in some examples, the first appearance of images may be satisfactory for archival or sharing purposes.

Besides manual image post-processing, automatic image post-processing functions can be implemented in systems described herein. Such image post-processing functions can include pre-configuration of the image post-processing functions, e.g., for rotation, face-detection, semi-automatic image post-processing functions, requiring limited user actions, or fully automatic image post-processing functions, including machine learning strategies to achieve good subjective image quality adapted to individual users.

Generally, examples described herein may implement image adjustment techniques in a variety of ways. In some examples, settings may be determined based on analysis of one or more calibration images (e.g., images of machine-readable symbols and/or images of a scene). Settings from initial image captured may be stored and used to apply to subsequently captured images. In other examples, individual captured images may be adjusted using computer vision methods and/or machine learning methods.

In examples utilizing stored settings, some example methods may proceed as follows. A user may capture a number of calibration photos of a scene. For example, a user may utilize camera 102 to capture one or more images of a scene. Any number of calibration images may be obtained including 1, 2, 3 4, 5, 6, 7, 8, 9, and/or 10 calibration images. Other numbers of calibration images may be obtained in other examples. Data corresponding to the calibration images may be transferred (e.g., through a wired or wireless connection) to another computing system, such as computing system 104 and/or computing system 106 where they may be displayed for a user. A user may manipulate one or more of the calibration images to flip, rotate, and/or center the calibration images. An average setting from the manipulation of the calibration images (e.g. an average amount the user adjusted a flip, rotate, and/or centering operation) may be stored as settings by the computing system 104 and/or computing system 106. The settings may be provided to the camera 102 in some examples. On receipt of subsequently captured images, the camera 102, computing system 104, and/or computing system 106 may apply the same manipulations to the subsequently captured images.

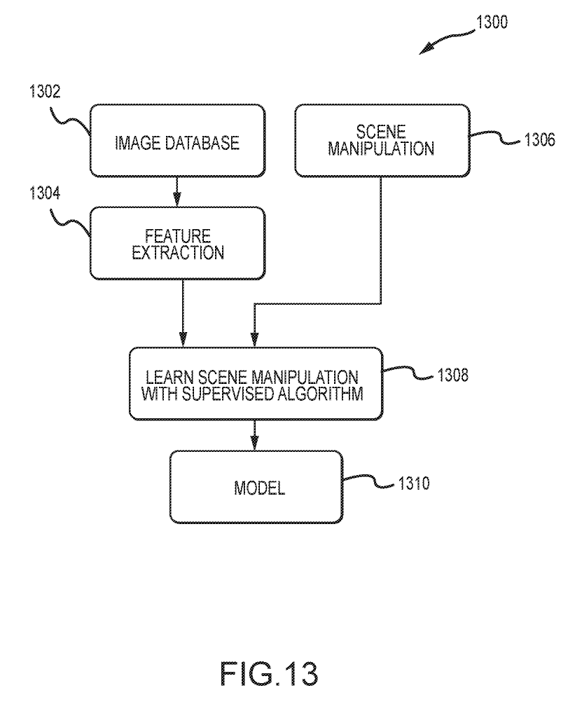

In examples where computer vision methods and/or machine learning methods are used, generally a training (e.g., offline) stage and an application stage may occur. FIG. 13 is a flowchart illustrating a training stage of an image adjustment technique utilizing machine learning arranged in accordance with examples described herein. The method 1300 may include performing feature extraction in block 1304 from images in a database 1302. A database of reference images may be provided for use as database 1302. The database 1302 may, for example, be in an electronic storage accessible to computing system 104 and/or computing system 106. The reference images in database 1302 may in some examples be selected to be relevant to images expected to be captured by camera 102. For example, images of similar content (e.g., city, beach, indoor, outdoor, people, animals, buildings) as may be expected to be captured by camera 102 may be included in database 1302. The reference images in database 1302 may have generally desired features (e.g., the reference images may have a desired alignment, orientation, and/or contrast). In some examples, however, the images in the database 1302 may not bear any relation to those expected to be captured by camera 102. Feature extraction is performed in block 1304. Features of interest may be extracted from the images in database 1302—features of interest may include, for example, people, animals, faces, objects, etc. Features of interest may additionally or instead include attributes of the reference images—e.g., metrics relating to orientation, alignment, magnification, contrast, or other image quality parameter.

Scene manipulation may be performed in block 1306. Scene manipulation may include manipulating training scenes (e.g., images) in a variety of increments. For example, a set of training images may be used to practice image adjustment. With reference to the features which had been extracted in block 1304, appropriate scene manipulations may be learned in block 1308 which result in features aligned in a similar manner to those extracted from images in block 1304 and/or which provide for image attributes similar to those extracted from images in block 1304. Accordingly, comparisons may be made between features in manipulated scenes and extracted features from block 1304. In some examples, those comparisons may be made with reference to a merit function. A merit function may be used which includes a combination (e.g., a sum) of weighted variables, where a sum of the weights is held constant (e.g., the sum of weights may equal 1 or 100 in some examples). The variables may be one or more metrics representing attributes of an image (e.g., orientation, alignment, contrast, and/or focus). The merit function may be evaluated on the reference images. As manipulations are made to training images during scene manipulation in block 1306, the merit function may be repeatedly evaluated on the training image. In some examples, a system may work to minimize a difference between the merit function evaluated on the training image and the merit function as evaluated on one or more of the training images. Any suitable supervised machine learning algorithm may be used, e.g. decision forest/regression forest, and/or neural networks. Training may occur several times—e.g., one training image may be processed several times using, e.g., a different order of adjustment operations and/or a different magnitude or type of adjustment operation, in order to search through a space of possible adjustments and arrive at an optimized or preferred sequence of adjustment operations.

In this manner, a model 1310 may be developed which describes manipulations which may be appropriate for certain scenes based on the training which as occurred in method 1300. The method 1300 may be performed by computing system 104 and/or computing system 106 in some examples. The model 1310 may be stored in computing system 104 and/or computing system 106 in some examples. In other examples, a different computing system may perform method 1300. The model 1310 may describe which manipulations were performed on a particular input image, and in what order, to optimize the merit function for the image.

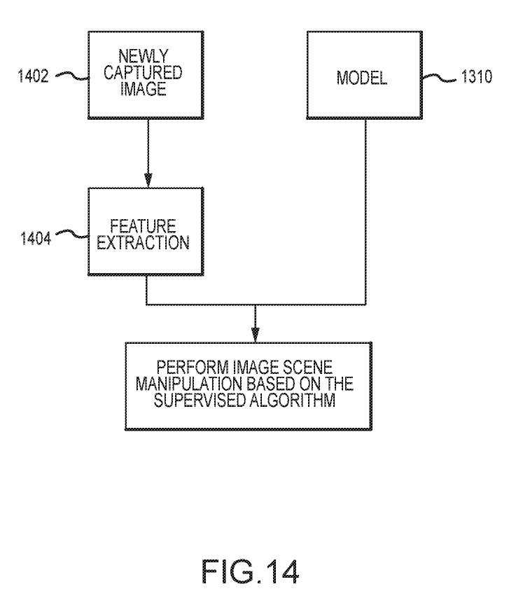

Once a model has been developed for manipulation of scenes, the model may be applied in practice to provide image adjustment. FIG. 14 is a flowchart illustrating an application stage of an image adjustment technique utilizing machine learning arranged in accordance with examples described herein. The method 1400 a newly captured image 1402 may be obtained (e.g., using camera 102). Data representative of image 1402 may be provided, for example, to computing system 104 and/or computing system 106. The computing system 104 and/or computing system 106 may perform feature extraction in block 1404 using the image 1402. The model 1310 may be stored on and/or accessible to computing system 104 and/or computing system 106. The computing system 104 and/or computing system 106 may utilize the model 1310 to perform image scene manipulation using a supervised algorithm in block 1406. For example, the features extracted in block 1404 may be compared to features of training images and/or reference images analyzed during the training stage. Based on the comparison, the model may identify a set and order of manipulations to perform on captured image 1402. Any of a variety of supervised algorithms may be used in block 1406 including K nearest neighbors classifier, linear or logistic regression. Naive Bayes classifier, and/or support vector machine classification/regression. In this manner, a desired scene manipulation may be learned based on extracted features from a database of training images. The manipulation may be applied to a new image of interest based on content of previously-learned training images. In some examples, the set of adjustments specified by the model 1310 may be only a starting sequence of adjustments. For example, after application of the adjustments specified by the model 1310, the system may continue to make further adjustments in an effort to optimize a merit function. Use of the adjustments specified by the model 1310 may speed up a process of optimizing a merit function in some examples. An entire adjustment space may not need to be searched through in order to optimize the merit function. A significant amount of optimization may be achieved through adjustments specified by the model 1310, and further image-specific adjustment may then be performed.

In some examples, image adjustment techniques may include image flipping. Images may be flipped 180 degrees (or another amount) in some examples (e.g. by the computing system 104 and/or computing system 106). In some examples, face detection may be used to implement image flipping. The computing system 104 and/or computing system 106 may be programmed to identify faces in images captured by the camera 102. Faces may be identified and may include facial features—e.g., eyes, nose, mouth. Based on relative positioning of facial features (e.g., eyes, nose, mouth), the image may be flipped such that the facial features are appropriately ordered (e.g., eyes above nose, nose above mouth).

In some examples, a color distribution of an image may be used to implement image flipping. For example, a sky may be identified in an outdoor scene by a mostly blue and/or grayish region. If the blue and/or grayish region of an outdoor scene is located at a bottom of a captured image, the computing system 104 and/or computing system 106 may flip the image such that the blue and/or grayish region is at a top of the captured image. In some examples, a flipping model may be learned in accordance with the methods in FIG. 13 and FIG. 14 based on extracted features from a database of labeled training images (e.g., flipped and not flipped) and a supervised classification algorithm may be applied to new images for correcting flipped image.

In some examples, image adjustment techniques may include rotating images. Example features used for rotating images for horizontal alignment may include identification of horizontal lines using computer vision methods, edge detectors (e.g., Sobel detector, Canny detector), line detector (e.g., Hough transform), identification of persons and their body posture using computer vision methods, face detection, and/or parts based models for silhouette extraction. These features may be extracted and manipulated to be oriented in an appropriate direction. Examples of a learning and classification strategy for implementing rotation may include learning a rotation model based on extracted features from a database of labeled training images (e.g., different degrees of rotations). A supervised classification and/or supervised regression algorithm may be applied to new images for correcting rotation.

In some examples, image adjustment techniques may include centering images. Centering an image may refer to a process of identifying an intended central feature (e.g., main content) of the image is at or near the center of the image. Examples of centering techniques include (multi-)face detection using computer vision methods. Generally, faces may be centered in an image. In a group of faces, a face in a center, or a midpoint between two central faces, may be centered in accordance with methods described herein. In some examples, (multi-)body detection using computer vision methods may be used. Generally, bodies may be centered in an image. In a group of bodies, a body in a center, or a midpoint between two central bodies, may be centered in accordance with methods described herein. In some examples, (multi-)object detection using computer vision methods may be used. Generally, objects may be centered in an image. In a group of objects, an object in a center, or a midpoint between two central objects, may be centered in accordance with methods described herein. Objects may include, for example, animals, plants, vehicles, buildings, and/or signs. In other examples, contrast, color distribution, and/or content distribution (e.g., a center of gravity after binary segmentation) may be used to center images. Examples of a learning and classification strategy for implementing centering may include learning how to center images based on extracted features from a database of labeled training images (e.g., different degrees of de-centering). A supervised classification and/or supervised regression algorithm may be applied to new images to center the image.

Due to computational requirements, image manipulation techniques may in some examples be implemented outside of the camera 102, e.g. using computing system 104 and/or computing system 106. In some examples, use of computing system 104, which may be an external unit, such as a case, may be advantageous because hardware of computing system 104 may be dedicated to performing image manipulation, and uncontrolled hardware changes or operation system and image processing library updates by smartphone manufacturers may be avoided. Similarly, implementing the image manipulation techniques on a specific unit such as computing system 104 may avoid a need to share information with a smartphone manufacturer or other device manufacturer and may aid in insuring in some examples that only post-processed images are available for better user experience, e.g., the user will not see the lower quality original images, e.g. with mis-alignment, tilts, etc.

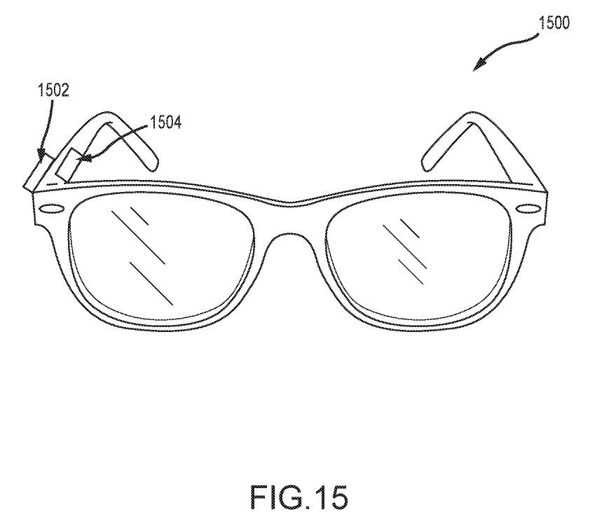

FIG. 15 is a schematic illustration of a wearable device system including a blink sensor arranged in accordance with examples described herein. The system 1500 includes camera 1502 which may be attached to eyewear. The camera 1502 may be provided on an outside of an eyewear temple, as shown. In other examples, the camera 1502 may be provided on the inside of the eyewear temple. In other examples, the camera 1502 may be worn and/or carried by a user in another manner (e.g., not attached to eyewear, but carried or worn on a hat, helmet, clothing, watch, belt, etc.). The camera 1502 may be implemented by and/or be used to implement any camera described herein, such as camera 102, camera 302, and/or camera 400.

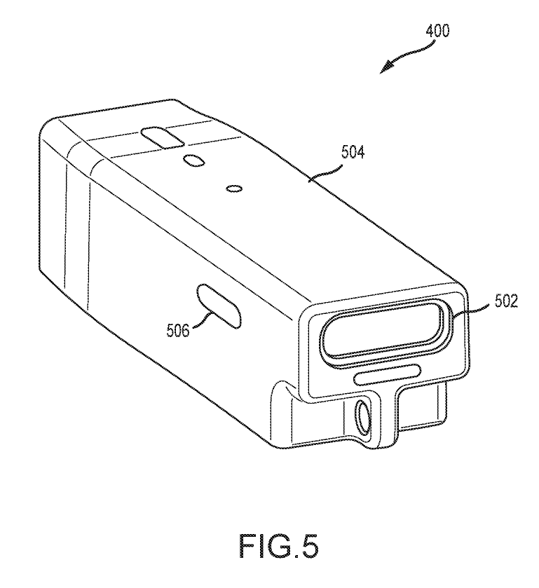

As described herein, a camera may have any number of inputs, as illustrated by input(s) 112 in FIG. 1. For example, one or more buttons may be provided on a camera as described with regard to button 406 and/or button 506 in FIG. 4 and FIG. 5. Another example of an input to a camera is an input from a sensor, which may be a wired or wireless input from a sensor. One or more blink sensors may be provided in some examples which may be in communication with cameras described herein. The blink sensor may detect an eyelid movement (e.g., a blink and/or a wink) of a user, and provide a signal to the camera 1502 indicative of the eyelid movement. Responsive to the signal indicative of the eyelid movement, the camera 1502 may be programmed to take one or more actions—e.g., capture an image, start and/or stop video acquisition, turn on, turn off, etc.

Accordingly, one or more blink sensors may be provided in apparatuses or systems described herein to control operation of wearable electronic devices (e.g., cameras) by sensing an eyelid movement such as a blink or wink. Wearable devices which may be controlled using blink sensors described herein include, but are not limited to a camera, a hearing aid, a blood pressure monitor, a UV meter, a motion sensor, a sensorimotor monitor based on analysis of blink patterns.

Blink sensors described herein may be mounted on an eyeglass frame. In some examples, one or two or more blink sensors may be mounted on the inner surface of an eyeglass frame. A variety of types of blink sensors (which may also be referred to as pupil sensors) may be used. Example sensor types include infrared sensors, pressure sensors, and capacitive sensors. For example, or more pressure sensors may sense a change in air pressure caused by eyelid movement (e.g., winking and/or blinking).

In some examples, additional components may be provided together with the blink sensor. The additional components and the blink sensor may in some examples be provided supported by a same substrate (e.g., in a strip) and disposed on an inside of a temple together with blink sensor 1504. For example, additional components may include a power source (e.g., a power generator), an antenna, and a microcontroller or other processing unit.

Power sources and/or power generators which may be used in blink sensor strips described herein may include a photocell and/or a Peltier thermoelectric power generator. In some examples, the blink sensor strip may not include a battery or a memory.

A size of the blink sensor strip may generally be on the order of millimeters, 5 mm×15 mm×0.5 mm in some examples. The strip may be mounted on the inner surface of an eyeglass temple or frame, near the hinge.

In some examples, a blink sensor may be coupled to an A/D converter for conversion of analog data generated by the blink sensor into digital data. An electrical power generator may be coupled to a power management system. The power management system may be coupled to the blink sensor and may provide power to the blink sensor. The A/D converter may provide the digital data to a microcontroller or other processing unit (e.g., processor and/or ASIC). In some examples, the power management system may also power the microcontroller or other processing unit. The microcontroller or other processing unit may be coupled to an antenna. The microcontroller or other processing unit may analyze the digital data provided by the A/D converter and determine an eyelid movement has occurred (e.g., a wink or a blink), and may transmit a signal indicative that an eyelid movement has occurred using the antenna. In other examples, the digital data provided by the A/D converter itself may be transmitted using the antenna. The signal indicative of eyelid movement and/or transmitted digital data may be received by, e.g., a receiver on a camera described herein. In some examples, wireless communication may not be used, and the microcontroller or other processing unit and/or the AD converter or sensor may be directly connected to a camera using a wired connection.

In some examples of a sensor strip, a blink sensor and a photocell may be provided. The blink sensor may be powered by the photocell. For example, a reverse Schotkey barrier photocell may be used, and may generate 1-10 microwatt from an area of 100μ×100μ at full sunlight outdoors. The photocell may measure 250 microns×250 microns, producing more than 6 microwatts outdoors (e.g., 0.1 to 2 kilocandelas per sq. meter), and up to 2 microwatts indoors (e.g., ambient illumination level of 100 candelas or more per sq. meter). The sensor strip may further include an ASIC or other processing unit, a power management system and an antenna, or subcombinations of those components.

In some examples, a sensor strip may include a Peltier heater as a power source. The high temperature junction of the Peltier heater may be at 32-35 C, and the low temperature junction may be at 25-30 C. Example dimensions of the Peltier device are 1 mm×1 mm×0.25 mm, generating about 10 microwatts from a temperature difference of about 7 C. Other components which may be included in a sensor strip with the Peltier heater include a blink sensor, an ASIC or microcontroller or other processing unit, a power management system (PMIC), and an antenna. Electrical power generated by the Peltier heater power source may be input into PMIC, which may open a gate providing power to the blink sensor when a threshold voltage level is reached.

In some example sensor strips, two different types of sensors may be used. For example, an infrared imaging device may be provided which may detect a level of ambient IR radiation at a frequency of 60 Hz or greater. A capacitance sensor may also be provided which may measure changes in air pressure caused by eyelid movement (e.g., by a blink or a wink). In some examples, one or more sensors may detect motion of muscles around an eye that are indicative of winking, blinking, or other eye movement. The sensor(s) may function when power and/or an activation trigger is received from an ASIC or microcontroller or other processing unit. The sensor output may be digitized by the microcontroller or ASIC or other processing unit, filtered, decoded, and compared to store values in a look up table, which may occur in real time, then sent to the PMIC circuit and the antenna for transmission as a trigger signal indicative of an eyelid movement to be received by a receiver (e.g., a WiFi receiver) of the wearable device (e.g., camera).

In some examples, multiple (e.g., two sensors) may be used. For example, one sensor may be provided to sense movement associated with the right eye and another sensor may be provided to sense movement associated with the left eye. For example, one sensor may be placed on an inside of one eyewear temple, and another sensor may be placed on an inside of the other eyewear temple. Measurements of each sensor may be compared, e.g., using a processing unit which may be included in a sensor strip (for example, both sensors may provide data, through a wired or wireless connection, to a same processing unit, which may be disposed in a sensor strip with one of the sensors in some examples). If the measurements of each sensor are equal, a blink of both eyes may be identified. Accordingly, if a wearable device (e.g., a camera) is configured to respond to a wink, it may not respond to a blink. If the measurements of each sensor are statistically different, a wink may be identified. In certain cases should a blink be desired or a series of blinks be desired then the measurements of each of the two sensors should be equal and in which case the measurements will not be discarded if an electronic wearable device (e.g., a camera) is configured to respond to a blink.

In some examples, a right sensor strip may be provided on a right eyewear temple, and a left sensor strip may be provided on a left eyewear temple. The right and left sensor strips may communicate wirelessly to an electronic wearable device e.g., a camera, to affect an operation of the electronic wearable device. In certain embodiments either the right or left sensor can be electrically connected to the electronic wearable device using a wired connection and the other sensor system strip can be wirelessly connected. In some examples, both sensor strips may have a wired connection with the electronic wearable device.

Accordingly examples described herein include wink sensor systems. A wink sensor system may include a sensor and electronics. The wink sensor system may effect an operation of a remote distance separated electronic wearable device. The wink sensor system may include a transmitter and a receiver. The sensor can sense an anatomical movement, IR, temperature, reflected light, air movement, or combinations thereof. The sensor may be implemented using a capacitive sensor, a pressure sensor, an IR sensor, or combinations thereof. The sensor may be powered by a photocell, a Peltier heater, a thermal electric cell, energy harvesting, or combinations thereof. The system may be devoid of a battery in some examples. The system may be devoid of a power source in some examples. The system may include a sensor for sensing the right eye, a sensor for sensing the left eye, and/or a sensor for sensing the both eyes. The system may include multiple sensors for one eye, and/or multiple sensors for both eyes. The system may include a sensor for sensing both eyes of a user and a measurement of the right eye may be compared to a measurement of the left eye. The system may affect an operation of an electronic wearable device based upon a measurement of a sensor. The system may disregard a measurement should a wink be desired and a measurement of the right eye be equal within an acceptable range of tolerance to a similar measurement of the left eye. The system may affect an operation of an electronic wearable device should blink be desired and a measurement of the right eye be equal within an acceptable range of tolerance to a similar measurement of the left eye.

The system can affect an operation of an electronic wearable device should a wink be desired and a measurement of the right eye be statistically different to a similar measurement of the left eye. The system can disregard an operation of an electronic wearable device should blink be desired and a measurement of the right eye be equal within an acceptable range of tolerance to a similar measurement of the left eye.

Electronics included in wink sensor systems may include a rechargeable battery. The sensor system can include a receiver and/or a transmitter. The electronic wearable device can include a receiver and/or a transmitter. The wink sensor system may be wirelessly coupled to an electronic wearable device for wireless communication. The electronic wearable device can be a camera (e.g., an image capture device), a communication device, a light, an audio device, an electronic display device, a switch, and/or a sensing device.

A wink sensor system may include a wink sensor, electronic wearable device and eyewear frame. The wink sensor may be located on the inside side of the eyewear frame and the electronic wearable device may be located on the outside side of the eyeglass frame. The sensor may sense an anatomical movement (e.g., eyelid movement), IR, temperature, reflected light, air movement, or combinations thereof. The sensor can be a capacitive sensor and/or an IR sensor. The sensor may be powered by a photocell, a Peltier heater, and/or energy harvesting. The system may include a sensor for sensing the right eye, a sensor for sensing the left eye, and/or a sensor for sensing the both eyes. A measurement of the right eye may be compared to a measurement of the left eye. The system can affect an operation of an electronic wearable device based upon a measurement of a sensor. The system can disregard a measurement should a wink be desired and a measurement of the right eye be equal within an acceptable range of tolerance to a similar measurement of the left eye. The system can affect an operation of an electronic wearable device should blink be desired and a measurement of the right eye be equal within an acceptable range of tolerance to a similar measurement of the left eye. The system can affect an operation of an electronic wearable device should a wink be desired and a measurement of the right eye be statistically different to a similar measurement of the left eye. The system can disregard an operation of an electronic wearable device should blink be desired and a measurement of the right eye be equal within an acceptable range of tolerance to a similar measurement of the left eye. The electronics may include a rechargeable battery. The sensor system and/or the wearable electronic device may include a receiver. The sensor system and/or electronic wearable device may include a transmitter. The wink sensor system may be supported by an eyewear frame. The wink sensor may be electrically connected to the electronic wearable device. The wink sensor system may be distance separated from the electronic wearable device. The wink sensor system may be wirelessly coupled to an electronic wearable device. The inside side of the eyeglass frame can be the inside side of a temple. The outside side of the eyeglass frame can be an outside side of a temple. The inside side of the eyeglass frame can be the inside side of the front of the eyeglass frame. The outside side of the eyeglass frame can be an outside side of the front of the eyeglass frame. The inside side of the eyeglass frame can be the inside side of the bridge of the eyeglass frame. The outside side of the eyeglass frame can be an outside side of the bridge of the eyeglass frame.

It should be understood that a blink can involve one or two eyes. A wink may involve only one eye. A wink is considered to be that of a forced blink. Examples described herein may compare a similar sensing measurement of the two eyes to one another. Examples described herein may sense only one eye and use a difference in measurement pertaining to one eye for sensing a blink versus a wink. By way of example only; time of lid closure, movement of an anatomical feature of the eye or around the eye or on the side of the head, time of sensing light reflection off the cornea, time of sensing a spike of heat from eye, air movement etc. may be used in some examples to distinguish a blink and a wink.

Examples described herein include cameras, and examples of wearable cameras have been described. In some examples, a flash may also be provided for wearable or portable cameras. In many examples a flash may not be required for wearable cameras, since they are most often used outdoors where plenty of light is available. For this reason, building a flash into the wearable camera has not typically been done, so that the camera size can be kept to a minimum. In cases where a flash is desirable, for example, while the camera is worn indoors, examples described herein may provide a flash.

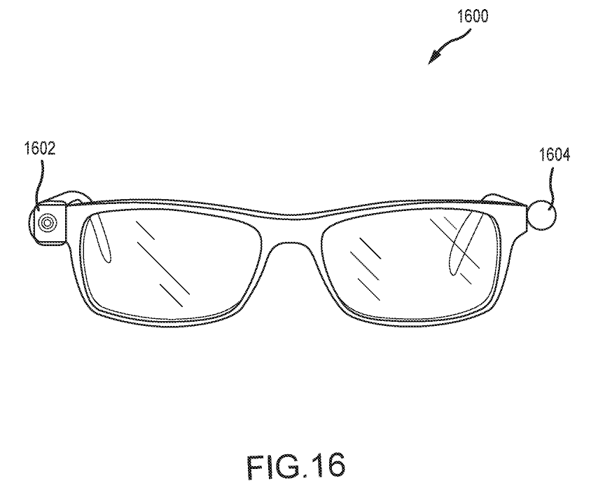

FIG. 16 is a schematic illustration of a wearable camera and flash system arranged in accordance with examples described herein. The system 1600 includes camera 1602 and flash 1604 provided on eyeglass frames. The camera 1602 may be implemented by and/or used to implement any camera described herein, including camera 102 and/or camera 400, for example. The flash 1604 may be used with any camera described herein, including camera 102 and/or camera 400 for example. The camera 1602 may be attached to the left or right side of a pair of spectacle lenses, as shown in FIG. 16. The flash 1604 may be worn on the opposite temple. The wearable camera and the wearable flash, while remote and distance separated, can be in wireless communication with one another.

In some examples, flash 1604 may be located on the opposite temple as camera 1602. Camera 1602 may control flash 1604 through a wireless communication link, such as Bluetooth or Wi-Fi. In some examples, a light meter may be used to detect the light level prior to activating the flash. The light meter may be included with flash 1604 to avoid wasting power by not using a flash when sufficient light is already available. In some examples, the light meter may be integrated with the flash 1604 itself to avoid adding more components to the camera 1602 and increasing the size of the camera 1602. In some examples, the light meter may be integrated in the camera 1602 and used to send the flash request to the flash 1604, when a photo is being taken and the light level is low enough to necessitate a flash or a flash is desired. In some examples, the light meter may form a separate component in communication with the camera 1602 and/or flash 1604.

In some examples, the camera 1602 may be used in combination with a base unit for charging the camera 1602 and/or for managing data from the camera 1602. For example, computing system 104 of FIG. 1 may be used to implement a base unit. The camera 1602 may be supported by, placed in, and/or plugged into a base unit when not work on the eyewear to charge the camera 1602 and/or to download data from the camera 1602 or other manage the camera 1602 or data of the camera 1602.

A flash may be built into the base unit. The camera 1602 may utilize wireless communication to communicate with the base unit when a flash is desired for a photo. A user may hold the base unit and aim it while taking the photo in some examples.

The above detailed description of examples is not intended to be exhaustive or to limit the method and system for wireless power transfer to the precise form disclosed above. While specific embodiments of, and examples for, the method and systems for wireless power transfer are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. It will be further appreciated that one or more components of base units, electronic devices, or systems in accordance with specific examples may be used in combination with any of the components of base units, electronic devices, or systems of any of the examples described herein.

What is claimed is:

1. A method comprising:
capturing a first image with a camera attached to a wearable device in a manner which fixes a line of sight of the camera relative to the wearable device;
transmitting the first image to a computing system;
receiving or providing an indication of an adjustment to a location relative to a center of the first image or an orientation of the first image;
generating a configuration parameter corresponding to the adjustment to the location relative to the center of the first image or the orientation of the first image;
storing the configuration parameter in memory of the computing system;
retrieving the configuration parameter following receipt of a second image from the camera; and
automatically adjusting the second image in accordance with the configuration parameter.

2. The method of claim 1, wherein the wearable device is eyewear.

3. The method of claim 1, wherein the wearable device is an eyeglass frame, an eyeglass frame temple, a ring, a helmet, a necklace, a bracelet, a watch, a band, a belt, a body wear, a head wear, an ear wear, or a foot wear.

4. A method comprising:
capturing an image with a camera coupled to an eyewear frame;
displaying the image together with a layout of regions; and
based on a region in which an intended central feature of the image appeared, recommending a wedge having a particular angle and orientation for attachment between the camera and the eyewear frame.

5. The method of claim 4, further comprising identifying, using a computer system, the intended central feature of the image.

6. The method of claim 4, further comprising attaching the wedge between the camera and the eyewear frame using magnets.

7. The method of claim 4, wherein the particular angle is based on a distance between a center of the image and the intended central feature.

8. The method of claim 4, wherein the orientation is based on which side of a center of the image the intended central feature appeared.

9. A camera system comprising:
an eyewear temple;
a camera attached to the eyewear temple; and
a wedge between the eyewear temple and the camera, wherein an angle of the wedge is selected to adjust a view of the camera.

10. The camera system of claim 9, wherein the angle of the wedge is select to align the view of the camera parallel to a desired line of sight.

11. The camera system of claim 9, wherein the wedge is attached to the camera and the eyewear temple with magnets.

12. The camera system of claim 9, wherein the wedge is integral with the camera or integral with a structure placed between the camera and the eyewear temple.

13. A method comprising:
holding a computing system in a particular position relative to a body-worn camera;
displaying a machine-readable symbol on a display of the computing system;
capturing an image of the machine-readable symbol with the body-worn camera; and
analyzing the image of the machine-readable symbol to determine an amount of rotation, shift, crop, or combinations thereof, to align the image of the machine-readable symbol with a view of a user.

14. The method of claim 13, wherein the machine-readable symbol comprises a grid, a bar code, a dot, or combinations thereof.

15. The method of claim 13, further comprising downloading the image of the machine-readable symbol from the body-worn camera to the computing system.

16. The method of claim 13, wherein said analyzing the image comprises comparing an orientation of the machine-readable symbol in the image with an orientation of the machine-readable symbol on the display.

17. A computing system comprising:
at least one processing unit; and
memory encoded with executable instructions which, when executed by the at least one processing unit, cause the computing system to:
receive an image captured by a wearable camera; and
manipulate the image in accordance with a machine learning algorithm based on a model developed using a training set of images.

18. The computing system of claim 17 wherein said manipulate the image comprises rotate the image, center the image, crop the image, stabilize the image, color balance the image, render the image in an arbitrary color scheme, restore true color of the image, noise reduction of the image, contrast enhancement of the image, selective alteration of image contrast of the image, enhancement of image resolution, image stitching, enhancement of field of view of the image, enhancement of depth of view of the image, or combinations thereof.

19. The computing system of claim 17 wherein said machine learning algorithm comprises one or more of decision forest/regression forest, neural networks, K nearest neighbors classifier, linear or logistic regression, naive Bayes classifier, or support vector machine classification/regression.

20. The computing system of claim 17, wherein the computing system further comprises one or more image filters.

21. The computing system of claim 17, wherein said computing system comprises an external unit into which the wearable camera may be placed to charge and/or transfer data.

22. The computing system of claim 17, wherein said computing system comprises a smartphone in communication with the wearable camera.

23. A system comprising:
a camera devoid of a viewfinder, the camera comprising:
an image sensor;
a memory; and
a sensor, wherein the sensor is configured to provide an output indicative of a direction of gravitation attraction; and
a computing system configured to receive data indicative of an image captured by the image sensor and the output indicative of the direction of gravitation attraction, the computing system configured to rotate the image based on the direction of gravitation attraction.

24. The system of claim 23, wherein the camera is attached to an eyewear temple.

25. The system of claim 23, wherein the camera is configured to provide feedback if the output indicative of the direction of gravitation attraction is outside a threshold prior to capturing the image.

26. The system of claim 23, wherein the feedback comprises optical, auditory, vibrational feedback, or combinations thereof.
